(19) United States
(12) Patent Application Publication
(10) Pub. No.: US 2026/0003467 A1
(43) Pub. Date: Jan. 1, 2026

(54) POSITION DETECTION DEVICE AND SENSOR PANEL

(71) Applicant: Wacom Co., Ltd., Saitama (JP)

(72) Inventors: Jun KADOWAKI, Saitama (JP); Tomohiro KAGAMI, Saitama (JP); Igor KARSUNTSEV, Saitama (JP)

(73) Assignee: Wacom Co., Ltd., Saitama (JP)

(21) Appl. No.: 19/320,652

(22) Filed: Sep. 5, 2025

Related U.S. Application Data
(63) Continuation of application No. PCT/JP2023/041079, filed on Nov. 15, 2023.

(30) Foreign Application Priority Data
Mar. 7, 2023 (JP) 2023-034327
Oct. 12, 2023 (JP) 2023-176991

(51) Int. Cl. G06F 3/044; G06F 3/0354; G06F 3/038; G06F 3/041

(52) U.S. Cl. CPC G06F 3/0446; G06F 3/038; G06F 3/041661; G06F 3/0448; G06F 3/03545; G06F 2203/04104

(57) ABSTRACT

A position detecting device includes a sensor panel having a first receiving electrode, a first transmitting electrode disposed so as to perpendicularly intersect the first receiving electrode, a second transmitting electrode disposed so as to extend in a direction parallel with the first transmitting electrode, and a second receiving electrode disposed so as to perpendicularly intersect the second transmitting electrode, a first sensor controller configured to detect a position on the sensor panel on a basis of signals detected by the first transmitting electrode and the first receiving electrode, generate electrode information related to the detection, and transmit the electrode information, and a second sensor controller configured to, on a basis of the electrode information, make a setting for processing of detecting a position on the sensor panel on a basis of signals detected from the second transmitting electrode and the second receiving electrode.

### BACKGROUND

### Technical Field

The present disclosure relates to a position detecting device and a sensor panel.

### Description of the Related Art

A position detecting device capable of detecting a contacted position and a depressed position is conventionally known. Such a position detecting device includes a sensor panel for having a plurality of linear electrodes arranged in a horizontal direction and a plurality of linear electrodes arranged in a vertical direction. The position detecting device detects a contact and a position as an electric signal when a stylus such as a pen or a finger comes into contact with linear electrodes.

In relation to this, Japanese Patent Laid-open No. 2019-121330 discloses a sensor panel including a plurality of first electrodes each extending in a first direction, arranged side by side in a second direction different from the first direction, and connected to an integrated circuit by first routing lines different from each other, and a plurality of second electrodes each extending in the second direction, arranged side by side in the first direction, and connected to the integrated circuit by second routing lines different from each other.

Recently, with an increase in size and a reduction in thickness of a display used integrally with the position detecting device, there has been a desire for an increase in size and a reduction in thickness of the position detecting device. However, with the technology described in Japanese Patent Laid-open No. 2019-121330, when the position detecting device is increased in size or reduced in thickness, capacitances accompanying the linear electrodes are increased, and there is consequently a possibility of a decrease in accuracy of detection of a contact and a position by the position detecting device. In addition, when the position detecting device is increased in size, there is a possibility of an increase in power consumption.

### BRIEF SUMMARY

The present disclosure has been made in view of the above listed problems. According to one aspect, the present disclosure describes a position detecting device and a sensor panel that can detect a position with high accuracy.

In addition, the present disclosure describes a position detecting device and a sensor panel that can detect a position with low power consumption.

In order to solve the above problems, a position detecting device according to a first aspect of the present disclosure includes a sensor panel having a first receiving electrode, a first transmitting electrode disposed so as to perpendicularly intersect the first receiving electrode, a second transmitting electrode having a first end adjacent to a first end of the first transmitting electrode and disposed so as to extend in a direction parallel with the first transmitting electrode, and a second receiving electrode disposed so as to perpendicularly intersect the second transmitting electrode. The position detecting device includes a first sensor controller configured to detect a position on the sensor panel on the basis of signals detected by the first transmitting electrode and the first receiving electrode, generate electrode information related to the detection, and transmit the electrode information. The position detecting device includes a second sensor controller configured to, on the basis of the electrode information transmitted from the first sensor controller, make a setting for processing of detecting a position on the sensor panel on the basis of signals detected from the second transmitting electrode and the second receiving electrode.

In addition, a position detecting device according to a second aspect of the present disclosure includes a sensor panel having a first transmitting electrode, a first receiving electrode disposed so as to perpendicularly intersect the first transmitting electrode, a second receiving electrode disposed in parallel with the first receiving electrode, and a third transmitting electrode perpendicularly intersecting the first receiving electrode and the second receiving electrode and arranged in parallel with the first transmitting electrode, a first sensor controller configured to detect a position on the sensor panel on the basis of signals detected by the first transmitting electrode and the first receiving electrode, generate electrode information related to the detection, and transmit the electrode information, and a second sensor controller configured to, on the basis of the electrode information transmitted from the first sensor controller, make a setting for processing of detecting a position on the sensor panel on the basis of signals detected from the second receiving electrode and the third transmitting electrode.

In addition, in the position detecting device according to a third aspect of the present disclosure, on the basis of the signals detected by the first transmitting electrode and the first receiving electrode, the first sensor controller generates detection information indicating whether the signals are detected, and generates the electrode information including the generated detection information.

In addition, in the position detecting device according to a fourth aspect of the present disclosure, a plurality of the first transmitting electrodes and a plurality of the first receiving electrodes are arranged on the sensor panel, and the first sensor controller generates position information indicating a position in a region in which the plurality of first transmitting electrodes and the plurality of first receiving electrodes intersect each other on the basis of signals detected by the first transmitting electrodes and the first receiving electrodes, and generates the electrode information including the generated position information.

In addition, in the position detecting device according to a fifth aspect of the present disclosure, the position information includes electrode identifying information indicating which of the plurality of first transmitting electrodes and the plurality of first receiving electrodes has detected a signal.

In addition, in the position detecting device according to a sixth aspect of the present disclosure, the position information includes coordinate information indicating the position in the region in which the plurality of first transmitting electrodes and the plurality of first receiving electrodes intersect each other.

In addition, in the position detecting device according to a seventh aspect of the present disclosure, the first sensor controller generates movement information including a movement direction and a movement speed of the position indicated by the coordinate information on the basis of a change between past coordinate information and present coordinate information, and includes the generated movement information in the position information.

In addition, in the position detecting device according to an eighth aspect of the present disclosure, the first sensor controller generates prediction information indicating a position to be reached by the position indicated by the coordinate information after passage of a predetermined time on the basis of the movement information, and includes the generated prediction information in the position information.

In addition, in the position detecting device according to a ninth aspect of the present disclosure, a plurality of the first transmitting electrodes, a plurality of the first receiving electrodes, a plurality of the second transmitting electrodes, and a plurality of the second receiving electrodes are arranged on the sensor panel, and the second sensor controller makes the setting so as to transmit a signal for position detection from the second transmitting electrodes in a vicinity of the position indicated by the electrode information according to the electrode information transmitted from the first sensor controller.

In addition, in the position detecting device according to a tenth aspect of the present disclosure, the second sensor controller makes the setting so as to increase a frequency of transmitting a signal for position detection from the transmitting electrode connected to the second sensor controller via a signal line according to the electrode information transmitted from the first sensor controller.

In addition, in the position detecting device according to an eleventh aspect of the present disclosure, a plurality of the first transmitting electrodes and a plurality of the first receiving electrodes are arranged on the sensor panel, and the first sensor controller performs an integral operation on each of signals detected by the first transmitting electrodes and the first receiving electrodes with a corresponding array of the electrodes as a reference, and generates the electrode information so as to include a result of the integral operation.

In addition, in the position detecting device according to a twelfth aspect of the present disclosure, a plurality of the first transmitting electrodes and a plurality of the first receiving electrodes are arranged on the sensor panel, and the first sensor controller determines, for each of signals detected by the first transmitting electrodes and the first receiving electrodes, whether or not a voltage value of the signal is equal to or higher than a second reference value, and generates the electrode information so as to associate electrode identifying information of an electrode, for which the determination is a positive determination, and the voltage value of the signal detected by the electrode with each other.

In addition, in the position detecting device according to a thirteenth aspect of the present disclosure, a plurality of the first transmitting electrodes, a plurality of the first receiving electrodes, a plurality of the second transmitting electrodes, and a plurality of the second receiving electrodes are arranged on the sensor panel, and, on the basis of signals detected by electrodes connected to the second sensor controller via signal lines and the electrode information, the second sensor controller detects a maximal value of voltage values of the respective signals as the position on the sensor panel.

In addition, in the position detecting device according to a fourteenth aspect of the present disclosure, a plurality of the first transmitting electrodes and a plurality of the first receiving electrodes are arranged on the sensor panel, and the first sensor controller calculates each of a zeroth-order moment value and a first-order moment value for the first transmitting electrodes and the first receiving electrodes on the basis of voltage values of respective signals detected by the first transmitting electrodes and the first receiving electrodes and distances of the electrodes detecting the signals from a reference position, and generates the electrode information so as to include the calculated zeroth-order moment value and the calculated first-order moment value.

In addition, in the position detecting device according to a fifteenth aspect of the present disclosure, a plurality of the second transmitting electrodes and a plurality of the second receiving electrodes are arranged on the sensor panel, and the second sensor controller calculates each of a zeroth-order moment value and a first-order moment value for the second transmitting electrodes and the first receiving electrodes on the basis of voltage values of respective signals detected by the second transmitting electrodes and the second receiving electrodes and distances of the electrodes detecting the signals from a reference position, calculates a gravity center of a detected region on the sensor panel detected by the first transmitting electrodes, the second transmitting electrodes, and the first receiving electrodes on the basis of the calculated zeroth-order moment value and the calculated first-order moment value and the zeroth-order moment value and the first-order moment value included in the electrode information, and detects the calculated gravity center as the position on the sensor panel.

In addition, in the position detecting device according to a sixteenth aspect of the present disclosure, a plurality of the first transmitting electrodes, a plurality of the first receiving electrodes, a plurality of the third transmitting electrodes, and a plurality of the second receiving electrodes are arranged on the sensor panel, the sensor panel has a first region including the plurality of first receiving electrodes and the second receiving electrode arranged in a vicinity of the first receiving electrodes among the plurality of second receiving electrodes and a second region including the plurality of second receiving electrodes and the first receiving electrode arranged in a vicinity of the second receiving electrodes among the plurality of first receiving electrodes and overlapping the first region as viewed in plan, the first sensor controller detects a position in the first region, and detects a position in an overlap region as a region in which the first region and the second region overlap each other as viewed in plan in a first period in detecting the position in the first region, and the second sensor controller detects a position in the second region, and detects a position in the overlap region in a second period continuous with the first period in detecting the position in the second region.

In addition, a position detecting device according to a seventeenth aspect of the present disclosure includes a sensor panel having a first receiving electrode, a first transmitting electrode disposed so as to perpendicularly intersect the first receiving electrode, a second transmitting electrode disposed so as to extend in a direction parallel with the first transmitting electrode such that a first end of the second transmitting electrode is adjacent to a first end of the first transmitting electrode, and a second receiving electrode disposed so as to perpendicularly intersect the second transmitting electrode, and a sensor controller configured to detect a position on the sensor panel on the basis of signals detected by the first transmitting electrode and the first receiving electrode, generate electrode information related to the detection, and make a setting for detection processing for position detection on the sensor panel by the second transmitting electrode and the second receiving electrode according to the electrode information.

In addition, in the position detecting device according to an eighteenth aspect of the present disclosure, a plurality of the first transmitting electrodes, a plurality of the first receiving electrodes, a plurality of the second transmitting electrodes, and a plurality of the second receiving electrodes are arranged on the sensor panel, and the sensor controller makes the setting according to the electrode information so as to transmit a signal for position detection from the second transmitting electrodes in a vicinity of the position indicated by the electrode information.

In addition, in the position detecting device according to a nineteenth aspect of the present disclosure, the sensor controller makes the setting according to the electrode information so as to increase a frequency of transmitting a signal for position detection from the second transmitting electrode.

In addition, a sensor panel according to a twentieth aspect of the present disclosure includes a first receiving electrode, a first transmitting electrode arranged in parallel with each other so as to perpendicularly intersect the first receiving electrode, a second transmitting electrode disposed so as to extend in a direction parallel with the first transmitting electrode such that a first end of the second transmitting electrode is adjacent to a first end of the first transmitting electrode, a second receiving electrode disposed so as to perpendicularly intersect the second transmitting electrode, a first signal line having a first end connected to a second end of the first transmitting electrode, a second signal line having a first end connected to a second end of the second transmitting electrode, a third signal line having a first end connected to a first end of the first receiving electrode and disposed between the first signal line and the second signal line, and a fourth signal line having a first end connected to a first end of the second receiving electrode and disposed between the second signal line and the third signal line.

In addition, in the sensor panel according to a twenty-first aspect of the present disclosure, the first ends of the first transmitting electrode and the second transmitting electrode are formed in a comb tooth shape, and the first end of the first transmitting electrode is formed so as to have a comb tooth-shaped recessed portion meshing with a comb tooth-shaped projecting portion of the first end of the corresponding second transmitting electrode and have a comb tooth-shaped projecting portion meshing with a comb tooth-shaped recessed portion of the first end of the corresponding second transmitting electrode.

In addition, a position detecting device according to a twenty-second aspect of the present disclosure includes a sensor panel formed by arranging a plurality of electrodes for position detection in a planar shape such that the plurality of electrodes intersect each other, the sensor panel having a first region that is one of regions in which the plurality of electrodes intersect each other, a second region that is one of the regions in which the plurality of electrodes intersect each other, the second region partly overlapping the first region as viewed in plan and being different from the first region, and an overlap region that is a region in which the first region and the second region overlap each other as viewed in plan, a first sensor controller configured to detect a position in the first region, and detect a position in the overlap region in a first period in detecting the position in the first region, and a second sensor controller configured to detect a position in the second region, and detect a position in the overlap region in a second period continuous with the first period in detecting the position in the second region.

In addition, in the position detecting device according to a twenty-third aspect of the present disclosure, the first sensor controller generates electrode information related to the detection of the position in the overlap region, and transmits the electrode information to the second sensor controller, and the second sensor controller makes a setting for processing of detecting the position in the overlap region on the basis of the electrode information transmitted from the first sensor controller.

In addition, in the position detecting device according to a twenty-fourth aspect of the present disclosure, the electrode information includes coordinate information indicating the position in the overlap region, and the second sensor controller detects a position in a region in a vicinity of the position indicated by the coordinate information in the second period.

According to the present disclosure, the position detecting device and the sensor panel can detect a position with high accuracy.

In addition, according to the present disclosure, the position detecting device and the sensor panel can detect a position with low power consumption.

### BRIEF DESCRIPTION OF THE DRAWINGS

FIG. 1 is a diagram illustrating a first example of a position detecting device;

FIG. 2 is a diagram illustrating a second example of the position detecting device;

FIG. 3A is a diagram illustrating another first example of the shape of electrodes;

FIG. 3B is a diagram illustrating another second example of the shape of the electrodes;

FIG. 4 is a diagram designed to assist in explaining the prediction of a position detected by the position detecting device;

FIG. 5 is a diagram designed to assist in explaining an integral operation on signals detected by the electrodes;

FIG. 6 is a diagram designed to assist in explaining a thinning-out operation on the signals detected by the electrodes;

FIG. 7 is a graph illustrating relation between the coordinates of the electrodes and obtained voltages;

FIG. 8 is a diagram designed to assist in explaining position detection in a case where a position indication by a finger straddles left and right regions on a sensor panel;

FIG. 9 is a diagram illustrating a third example of the position detecting device;

FIG. 10 is a diagram illustrating a fourth example of the position detecting device;

FIG. 11 is a flowchart illustrating an example of a flow of a series of operations of the position detecting device;

FIG. 12A is a diagram illustrating a first example of the switching of an operation mode;

FIG. 12B is a diagram illustrating another example of the switching of the operation mode when electrode information is transmitted and received;

FIG. 12C is a diagram illustrating a second example of the switching of the operation mode;

FIG. 13 is a diagram illustrating an apparatus mounted with the position detecting device;

FIG. 14 is a diagram illustrating a fifth example of the position detecting device;

FIG. 15A is a diagram designed to assist in explaining position detection in a case where a first sensor controller detects a position indication;

FIG. 15B is a diagram designed to assist in explaining position detection in a case where a second sensor controller detects a position indication; and

FIG. 16 is a diagram designed to assist in explaining the detection of a position.

### DETAILED DESCRIPTION

Embodiments of the present disclosure (which embodiments will hereinafter be referred to as “present embodiments”) will hereinafter be described with reference to the accompanying drawings. In order to facilitate understanding of the description, same constituent elements and steps in the drawings are identified by the same reference numerals as much as possible, and repeated description thereof will be omitted.

### First Embodiment

A first embodiment will now be described.

### Configuration

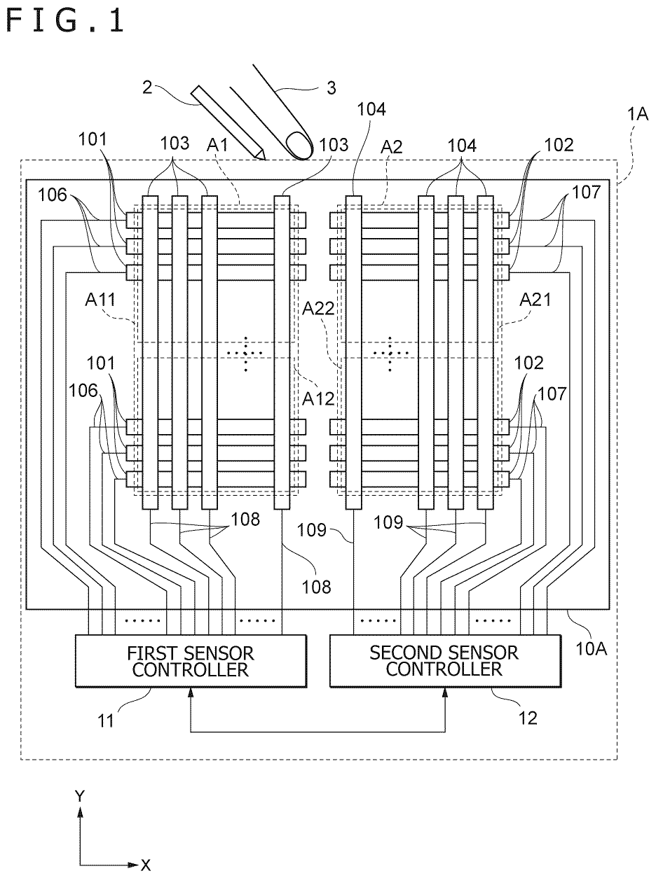

FIG. 1 is a diagram illustrating an example of a position detecting device 1A according to the first embodiment. The position detecting device 1A detects a position indicated by a stylus 2 or a finger 3 of a user, and performs various types of information processing according to a result of the detection. A main part of the position detecting device 1A is configured by including, for example, a sensor panel 10A, a first sensor controller 11, and a second sensor controller 12. The position detecting device 1A may further include a host processor, a memory, a communication module (not shown in the illustrations), and the like. In addition, the position detecting device 1A is, for example, a computer owned by a user, and is mounted in, for example, a tablet, a smart phone, a personal computer, or the like.

The stylus 2 is, for example, an active capacitive coupling type stylus that includes a power supply, a communication circuit, and an electrode for detecting an uplink signal transmitted in a predetermined cycle from the first sensor controller 11 and the second sensor controller 12 and transmitting a downlink signal at a time specified with the detected uplink signal set as a reference time.

The sensor panel 10A is a capacitive type sensor formed by arranging a plurality of detecting electrodes in a planar manner. This sensor panel 10A includes, for example, a plurality of X-line electrodes (hereinafter referred to as “receiving electrodes 103” or “receiving electrodes 104”) for detecting a position on an X-axis of a sensor coordinate system and a plurality of Y-line electrodes (hereinafter referred to as “transmitting electrodes 101” or “transmitting electrodes 102”) for detecting a position on a Y-axis of the sensor coordinate system. The transmitting electrodes 101 and 102 and the receiving electrodes 103 and 104 may be formed of a transparent conductive material including indium tin oxide (ITO), or may be formed by a wire mesh sensor. The sensor panel 10A may be flexible and capable of being bent while maintaining functionality with the transmitting electrodes 101 and 102 and the receiving electrodes 103 and 104 provided on the sensor panel 10A. The upper surface of the sensor panel 10A may be provided with a flexible cover material such as a cover film. Embodiments described are not limited as such, and some embodiments of the sensor panel 10A may not be flexible. In addition, the upper surface may be provided with an inflexible cover material such as glass.

The transmitting electrodes 101 are plurally arranged on the sensor panel 10A so as to extend in an X-axis direction and so as to be parallel with each other. The transmitting electrodes 101 are oriented such that a first end of each respective transmitting electrode 101 faces in a right edge direction of the sensor panel 10A, and a second end of each respective transmitting electrode 101 faces in a left edge direction of the sensor panel 10A. Further, the first ends of transmitting electrodes 101 are oriented adjacent to and facing second ends of corresponding transmitting electrodes 102. In addition, the second ends of transmitting electrodes 101 not adjacent to the transmitting electrodes 102 are connected to the first sensor controller 11 via signal lines 106.

The transmitting electrodes 102 are plurally arranged on the sensor panel 10A so as to extend in a direction parallel with the transmitting electrodes 101 and so as to be parallel with each other. Here, on the sensor panel 10A, the transmitting electrodes 102 equal in number to the number of the transmitting electrodes 101 are arranged on extensions of the transmitting electrodes 101 in the X-axis direction. The transmitting electrodes 102 are oriented such that a first end of each respective transmitting electrode 102 faces in a left edge direction of the sensor panel 10A, and a second end of each respective transmitting electrode 102 faces in a right edge direction of the sensor panel 10A. In addition, the transmitting electrodes 102 are respectively associated with the transmitting electrodes 101. First ends of transmitting electrodes 102 are oriented adjacent to and facing second ends of corresponding transmitting electrodes 101. Second ends of transmitting electrodes 102 not adjacent to the transmitting electrodes 101 are connected to the second sensor controller 12 via signal lines 107. The receiving electrodes 103 are plurally arranged on the sensor panel 10A so as to perpendicularly intersect the transmitting electrodes 101 and so as to be parallel with respect to one another. The receiving electrodes 103 are oriented such that a first end of each respective receiving electrode 103 faces an upper edge direction of the sensor panel 10A, and a second end of each respective receiving electrode 103 faces in a lower edge direction of the sensor panel 10A. In addition, the second ends facing the lower edge direction of the sensor panel 10A are connected to the first signal controller 11 via signal lines 108. Further, together with a plurality of the transmitting electrodes 101, the receiving electrodes 103 form a region A1 including respective points of intersection of the transmitting electrodes 101 and the receiving electrodes 103 on the sensor panel 10A. The region A1 includes an upper half region A11 from the center of the sensor panel 10A and a lower half region A12 from the center of the sensor panel 10A.

The receiving electrodes 104 are plurally arranged on the sensor panel 10A so as to perpendicularly intersect the transmitting electrodes 102 and so as to be parallel with respect to one another. The receiving electrodes 104 are oriented such that a first end of each respective receiving electrode 104 faces an upper edge direction of the sensor panel 10A, and a second end of each respective receiving electrode 104 faces in a lower edge direction of the sensor panel 10A. In addition, the second ends facing the lower edge direction of the sensor panel 10A are connected to the second signal controller 12 via signal lines 109. Further, together with the plurality of transmitting electrodes 102, the receiving electrodes 104 form a region A2 including respective points of intersection of the transmitting electrodes 102 and the receiving electrodes 104 on the sensor panel 10A. The region A2 includes an upper half region A21 from the center of the sensor panel 10A and a lower half region A22 from the center of the sensor panel 10A.

The signal lines 106 are plurally provided on the sensor panel 10A, and transmit signals between the transmitting electrodes 101 and the first sensor controller 11. The signal lines 106 are respectively associated with the transmitting electrodes 101. First ends of each respective signal line 106 are connected to the second ends of the corresponding transmitting electrodes 101, and the second ends of the signal lines 106 are connected to the first sensor controller 11 from the lower edge side of the sensor panel 10A. Additionally, the second ends of the signal lines 106 are provided on the left edge side of the second ends of the signal lines 108 to be described later on the sensor panel 10A.

The signal lines 107 are plurally provided on the sensor panel 10A, and transmit signals between the transmitting electrodes 102 and the second sensor controller 12. The signal lines 106 are respectively associated with the transmitting electrodes 102. First ends of each respective signal line 107 are connected to the second end of each corresponding transmitting electrode 102, and the second ends of the signal lines 107 are connected to the second sensor controller 12 from the lower edge side of the sensor panel 10A. Additionally, the second ends of the signal lines 107 are provided on the right edge side of the second ends of the signal lines 109 to be described later on the sensor panel 10A.

The signal lines 108 are plurally provided on the sensor panel 10A, and transmit signals between the plurality of receiving electrodes 103 and the first sensor controller 11. The signal lines 108 are respectively associated with the receiving electrodes 103. First ends of each respective signal line 108 are connected to the second ends of each corresponding receiving electrode 103, and the second ends of the signal lines 108 are connected to the first sensor controller 11 from the lower edge side of the sensor panel 10A. Additionally, the second ends of the signal lines 108 are provided on the right edge side of the second ends of the signal lines 106 and on the left edge side of the second ends of the signal lines 109 on the sensor panel 10A. That is, the signal lines 108 are provided between the signal lines 106 and the signal lines 109 to be described later in the X-axis direction.

The signal lines 109 are plurally provided on the sensor panel 10A, and transmit signals between the plurality of receiving electrodes 104 and the second sensor controller 12. The signal lines 109 are respectively associated with the receiving electrodes 104. First ends of each respective signal line 109 are connected to the second ends of each corresponding receiving electrode 104, and the second ends of the signal lines 109 are connected to the second sensor controller 12 from the lower edge side of the sensor panel 10A. Additionally, the second ends of the signal lines 109 are provided on the right edge side of the other ends of the signal lines 108 and on the left edge side of the second ends of the signal lines 107 on the sensor panel 10A. That is, the signal lines 109 are provided between the signal lines 107 and the signal lines 108 in the X-axis direction.

The first sensor controller 11 and the second sensor controller 12 are functionally configured to be able to detect positions indicated by the stylus 2 and the finger 3 of the user on the sensor panel 10A and receive a data signal transmitted by the stylus 2 by reading and executing a program stored in a memory by a processor. The detection of the position indicated by the stylus 2 is performed by an active capacitive coupling system. The detection of the position of the finger 3 of the user is performed by a capacitive system. The first sensor controller 11 detects an indicated position in the region A1 on the sensor panel 10A. The second sensor controller 12 detects an indicated position in the region A2 on the sensor panel 10A. In addition, the first sensor controller 11 and the second sensor controller 12 are configured to be able to communicate with each other. The first sensor controller 11 and the second sensor controller 12 share information regarding the detected positions by transmitting and receiving the information to and from each other, and make a setting for position detection processing on the basis of the shared information regarding the positions. In addition, one of the first sensor controller 11 and the second sensor controller 12 converts the shared information regarding the positions in the regions A1 and A2 into information regarding the positions in a region including the regions A1 and A2 on the sensor panel 10A, and transmits the converted information to another device in an apparatus 20 mounted with the position detecting device 1A. Incidentally, the information regarding the detected positions, the setting for the position detection processing, a transmitting and receiving method, and the like will be described later, and therefore a description thereof will be omitted here.

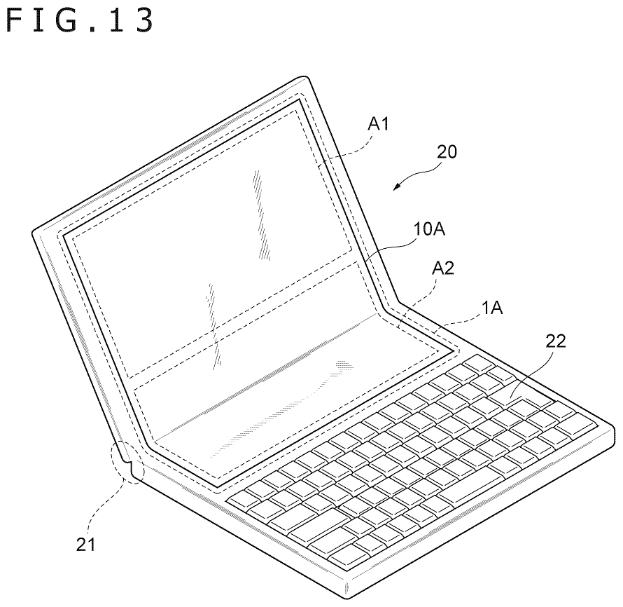

Incidentally, as described above, the sensor panel 10A has flexibility, and thus can be bent. Referring to FIG. 13, a description will be made of a state in which the sensor panel 10A is bent in a case where the apparatus 20 mounted with the position detecting device 1A can be bent. FIG. 13 is a diagram illustrating the apparatus 20 mounted with the position detecting device 1A.

The apparatus 20 is a tablet, and includes the position detecting device 1A, a keyboard 22, and a bending mechanism 21. The position detecting device 1A is disposed so as to be adjacent to the keyboard 22 in the apparatus 20. In addition, the bending mechanism 21 is a mechanism for bending the apparatus 20, and is provided to a lower portion in the vicinity of the region A2 of the sensor panel 10A in the position detecting device 1A. The keyboard 22 is a device for the user to perform input to the apparatus 20, and is disposed so as to be adjacent to the position detecting device 1A in the apparatus 20.

As illustrated in FIG. 13, a boundary between the regions A1 and A2 in the position detecting device 1A may be different from the position of the bending mechanism 21 of the apparatus 20. In addition, the boundary between the regions A1 and A2 in the position detecting device 1A may be the same as the position of the bending mechanism 21 of the apparatus 20.

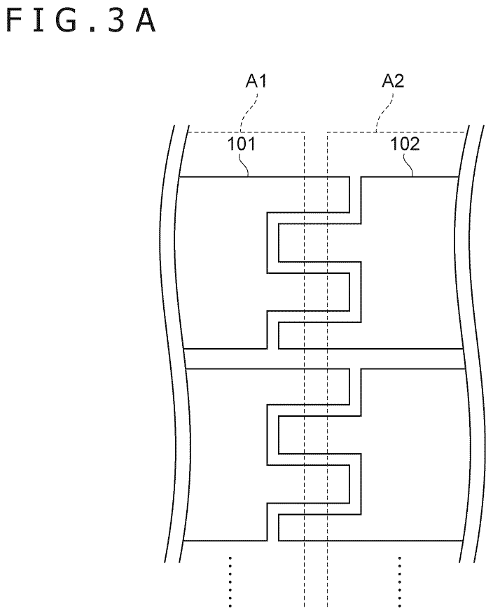

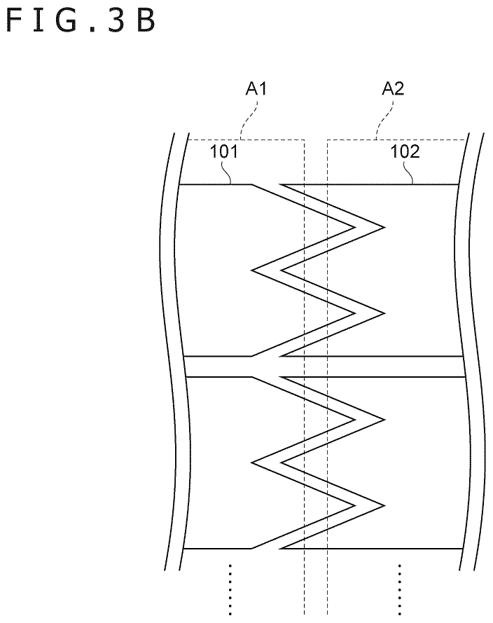

It is to be noted that, while, in the present example, the first ends of the transmitting electrodes 101 and 102 on the sensor panel 10A have a linear shape and face each other at the boundary between the regions A1 and A2, other embodiments are not limited as such. Here, referring to FIG. 3A and FIG. 3B, a description will be made of shapes of the first ends of the transmitting electrodes 101 and 102. FIG. 3A is a diagram illustrating another first example of the shape of the transmitting electrodes 101 and 102.

In FIG. 3A, the first ends of the transmitting electrodes 101 and 102 are formed in a comb tooth shape. In addition, the first ends of the transmitting electrodes 101 are formed so as to have comb tooth-shaped recessed portions meshing with comb tooth-shaped projecting portions of the first ends of the corresponding transmitting electrodes 102 and have comb tooth-shaped projecting portions meshing with comb tooth-shaped recessed portions of the first ends of the corresponding transmitting electrodes 102. In addition, the first ends of the transmitting electrodes 102 are formed so as to have the comb tooth-shaped recessed portions meshing with the comb tooth-shaped projecting portions of the first ends of the corresponding transmitting electrodes 101 and have the comb tooth-shaped projecting portions meshing with the comb tooth-shaped recessed portions of the first ends of the corresponding transmitting electrodes 101.

FIG. 3B is a diagram illustrating another example of the shape of the transmitting electrodes 101 and 102. In FIG. 3B, the first ends of the transmitting electrodes 101 and 102 are formed in a triangular wave shape. In addition, the first ends of the transmitting electrodes 101 are formed so as to have triangular wave-shaped recessed portions meshing with triangular wave-shaped projecting portions of the first ends of the corresponding transmitting electrodes 102 and have triangular wave-shaped projecting portions meshing with triangular wave-shaped recessed portions of the first ends of the corresponding transmitting electrodes 102. In addition, the first ends of the transmitting electrodes 102 are formed so as to have the triangular wave-shaped recessed portions meshing with the triangular wave-shaped projecting portions of the first ends of the corresponding transmitting electrodes 101 and have the triangular wave-shaped projecting portions meshing with the triangular wave-shaped recessed portions of the first ends of the corresponding transmitting electrodes 101.

In the cases where the first end of each of the transmitting electrodes 101 and 102 is formed as illustrated in FIG. 3A and FIG. 3B, the transmitting electrodes 101 and 102 are present on the same coordinate in the X-axis direction in the vicinity of the boundary between the regions A1 and A2 on the sensor panel 10A. Hence, when the position detecting device 1A detects a signal generated by contact of the stylus 2 or the finger 3 in the vicinity of the boundary between the regions A1 and A2, the position detecting device 1A can detect the signal by the first sensor controller 11 and the second sensor controller 12 at the same coordinate in the X-axis direction and the same signal strength.

Incidentally, the first end of each of the transmitting electrodes 101 and 102 illustrated in FIG. 3A and FIG. 3B may be provided with a plurality of projecting portions and a plurality of recessed portions. In addition, the transmitting electrodes 101 and 102 and the receiving electrodes 103 may be mesh electrodes in which a conductor is formed in a mesh shape. In a case where the transmitting electrodes 101 and 102 and the receiving electrodes 103 are mesh electrodes, the shape of the first ends of the transmitting electrodes 101 and 102 is the shape of contours of the mesh electrodes.

Returning to FIG. 1, the details of operation of the first sensor controller 11 and the second sensor controller 12 will now be described. The first sensor controller 11 and the second sensor controller 12 have an idle mode, and four kinds of active modes, which are to be illustrated in the following as operation modes. When the first sensor controller 11 and the second sensor controller 12 operate in the active mode, the first sensor controller 11 and the second sensor controller 12 control the position detecting device 1A while selecting these four kinds of modes in an order to be illustrated in the following. Incidentally, while, in the present example, a description will be made of a case of the first sensor controller 11, the second sensor controller 12 also performs the same control except that the electrodes and the signal lines for the second sensor controller 12 are different, and therefore a description thereof will be omitted.

A first mode is a mode of detecting the position of the finger 3. In the first mode, the first sensor controller 11, for example, transmits a touch detection signal from the transmitting electrodes 101 by supplying a transmission signal to the transmitting electrodes 101 via the signal lines 106. In addition, in the first mode, the first sensor controller 11, for example, detects the touch detection signal transmitted from the transmitting electrodes 101 by the receiving electrodes 103. Here, the first sensor controller 11 detects the finger 3 on the basis of a change in the touch detection signal due to a change in capacitance that accompanies contact of the finger 3 with the upper surface of the transmitting electrodes 101 and the receiving electrodes 103. Specifically, the first sensor controller 11 detects the presence or absence of contact of the finger 3 with the sensor panel 10A and the position of the contact on the basis of differences between the voltages of signals detected by the receiving electrodes 103 according to whether or not the finger 3 is in contact with the upper surface of the transmitting electrodes 101 and the receiving electrodes 103. Details of a method of detecting the position in the sensor panel 10A will be described later, and therefore a description thereof will be omitted here. In addition, while, in the present example, the first sensor controller 11 transmits the touch detection signal from the transmitting electrodes 101, and detects the touch detection signal by the receiving electrodes 103, other embodiments are not limited to this. The touch detection signal may be transmitted from the receiving electrodes 103, and the touch detection signal may be detected by the transmitting electrodes 101.

A second mode is a mode of transmitting an uplink signal to the stylus 2. In the second mode, the first sensor controller 11, for example, transmits the uplink signal from the transmitting electrodes 101 by supplying a transmission signal to the transmitting electrodes 101 via the signal lines 106. At this time, the first sensor controller 11 may select electrodes in the vicinity of a position indicated by the stylus 2 among the transmitting electrodes 101 and transmit the uplink signal or simultaneously select all of the transmitting electrodes 101 and transmit the uplink signal. The uplink signal is a signal for specifying a local identification (ID) assigned to the stylus 2 by the first sensor controller 11, a time interval at which the stylus 2 is to transmit a signal, and the like. The stylus 2 performs an operation of transmitting a downlink signal to the first sensor controller 11 and the like according to an instruction included in the uplink signal.

A third mode is a mode of detecting the position of the stylus 2 by detecting a position signal as an unmodulated burst signal transmitted from the stylus 2. In the third mode, the first sensor controller 11 selects the plurality of the transmitting electrodes 101 and the receiving electrodes 103 in order one at a time or a plurality at a time, and detects the voltage values of signals transmitted from the selected transmitting electrodes 101 or the selected receiving electrodes 103 via the signal lines 106 or 108. The first sensor controller 11 detects a position on the sensor panel 10A on the basis of the detected voltage value of each of the transmitting electrodes 101 and the receiving electrodes 103. Incidentally, details of a method of detecting the position on the sensor panel 10A will be described later, and therefore a description thereof will be omitted here.

A fourth mode is a mode of receiving a data signal transmitted by the stylus 2. The data signal is a signal that is phase-modulated on the basis of data and which has a fixed frequency and a fixed amplitude. The data includes data including information regarding a unique ID for identifying the stylus 2, the unique ID being an ID different from the local ID, and information regarding a pen pressure detected by the stylus 2. Either of the transmitting electrodes 101 and the receiving electrodes 103 may be used when receiving the data signal. However, in the following, a description will be made of a case where the data signal is received by using the transmitting electrodes 101. In the fourth mode, the first sensor controller 11 simultaneously selects a plurality of transmitting electrodes 101, for example, three transmitting electrodes 101 with a transmitting electrode 101 closest to the position indicated by the stylus 2 at a center. In this state, the first sensor controller 11 periodically reads signals detected from the transmitting electrodes 101. Incidentally, in selecting the transmitting electrodes 101, the first sensor controller 11 may select only one transmitting electrode 101 closest to the position indicated by the stylus 2.

The idle mode is a mode of stopping one or both of the detection of the finger 3 and the detection of the stylus 2. In the idle mode, when the first sensor controller 11 receives information regarding a position in the region A2 from the second sensor controller 12, the first sensor controller 11 shifts the mode to one of the first to fourth modes of the active mode.

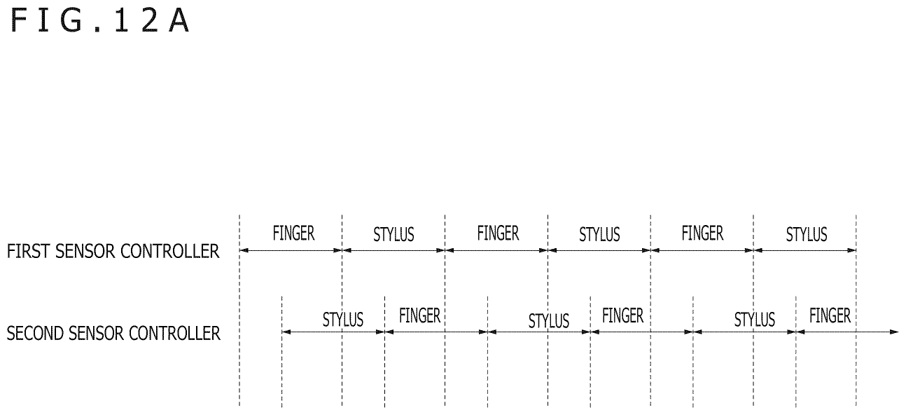

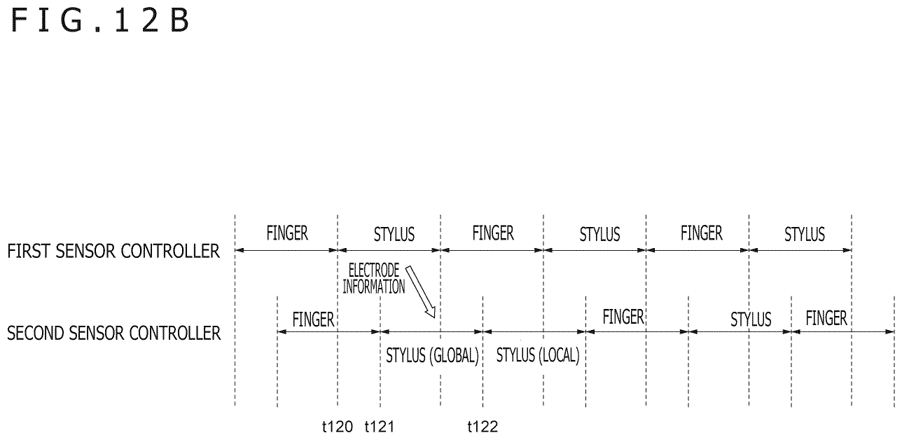

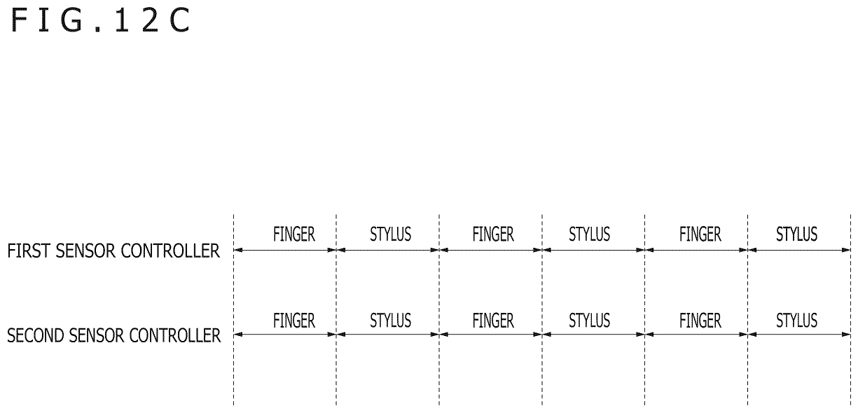

Mode changing relations in the first sensor controller 11 and the second sensor controller 12 will be described with reference to FIG. 12A and FIG. 12C. FIG. 12A is a diagram illustrating a first example of the switching of the operation mode. In a period denoted as “finger” in FIG. 12A, the first sensor controller 11 and the second sensor controller 12 each operate in the first mode. In addition, in a period denoted as “stylus” in FIG. 12A, the first sensor controller 11 and the second sensor controller 12 each operate by selecting modes from the second mode to the fourth mode.

As illustrated in FIG. 12A, the first sensor controller 11 and the second sensor controller 12 operate without the periods of the respective modes being in synchronism with each other. In addition, when the first sensor controller 11 generates electrode information, and transmits the generated electrode information to the second sensor controller 12, the second sensor controller 12 makes a detection setting so as to scan the vicinity of the region A1 on the basis of the electrode information. The setting will be described later, and therefore a description thereof will be omitted here.

FIG. 12C is a diagram illustrating a second example of the switching of the operation mode. As illustrated in FIG. 12C, the first sensor controller 11 and the second sensor controller 12 may operate with the periods of the respective modes in synchronism with each other.

### Flow of Series of Operations

The above description discusses the operation of the first sensor controller 11 in each mode. As is understood from the above description, the position detecting device 1A is configured to perform signal transmission and reception by using the same sensor panel 10A for the transmission and the reception. Next, details of a method of detecting a position on the sensor panel 10A in the first sensor controller 11 and the second sensor controller 12 will be described.

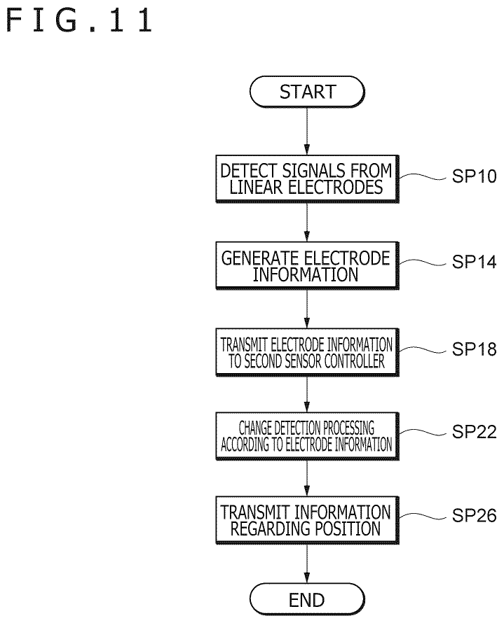

FIG. 11 is a flowchart illustrating an example of a flow of a series of operations of the position detecting device 1A. In the present example, a description will be provided of a case where the first sensor controller 11 detects a position in the region A1 on the sensor panel 10A and transmits the detected information to the second sensor controller 12. As for a case where the second sensor controller 12 detects a position in the region A2 on the sensor panel 10A and transmits the detected information to the first sensor controller 11, the same control is performed except that the electrodes, the signal lines, the region as a detection target, and the like are different, and therefore a description thereof will be omitted.

### (Step SP10)

The position detecting device 1A receives signals detected by the transmitting electrodes 101 and the receiving electrodes 103 by the first sensor controller 11. The reception of the signals is performed in the first mode and the third mode in a cycle in which the first sensor controller 11 selects the modes from the first mode to the fourth mode in order. Then, the processing proceeds to the processing of step SP14.

### (Step SP14)

The position detecting device 1A generates electrode information regarding a position on the sensor panel 10A by the first sensor controller 11 on the basis of the signals received from the transmitting electrodes 101 and the receiving electrodes 103. The electrode information is information regarding a position in the region A1 detected by the transmitting electrodes 101 and the receiving electrodes 103. The electrode information includes, for example, detection information and position information. The first sensor controller 11 generates the electrode information so as to include the detection information and the position information in the processing of step SP14. Then, the processing proceeds to the processing of step SP18.

Before the processing of step SP18 is described, a description will be made of the detection information and the position information included in the electrode information. The detection information is information indicating whether or not a position in the region A1 is detected by the transmitting electrodes 101 and the receiving electrodes 103. The detection information is generated by the first sensor controller 11. Specifically, the first sensor controller 11 determines whether or not one of the respective signals detected by the transmitting electrodes 101 and the receiving electrodes 103 indicates that a position in the region A1 is detected. On the one hand, when one of the respective signals detected by the transmitting electrodes 101 and the receiving electrodes 103 indicates that a position in the region A1 is detected, the first sensor controller 11 sets the detection information to a detected state indicating that a position indication by the finger 3 or the stylus 2 is detected in the region A1. On the other hand, when none of the respective signals detected by the transmitting electrodes 101 and the receiving electrodes 103 indicates that a position in the region A1 is detected, the first sensor controller 11 sets the detection information to an undetected state indicating that no position indication by the finger 3 or the stylus 2 is detected in the region A1.

The position information is information indicating a position indicated by the stylus 2, the finger 3, or the like in the region A1. The position information is generated by the first sensor controller 11 on the basis of the signals detected by the transmitting electrodes 101 and the receiving electrodes 103. The position information includes, for example, some or all of electrode identifying information, coordinate information, movement information, and prediction information.

The electrode identifying information is information indicating which electrode of the plurality of the transmitting electrodes 101 and the receiving electrodes 103 has detected a signal. Specifically, the electrode identifying information includes information regarding which of the transmitting electrodes 101 and the receiving electrodes 103 is an electrode that has detected a signal indicating that there is a position indication by the stylus 2 or the finger 3 in the region A1 among the plurality of the transmitting electrodes 101 and the receiving electrodes 103. The electrode identifying information also includes information regarding what ordinal number the electrode corresponds to when counted from an upper end, a lower end, a left end, or a right end, electrode identification numbers associated with the transmitting electrodes 101 and the receiving electrodes 103 in advance, and the like. The electrode identifying information is generated by the first sensor controller 11.

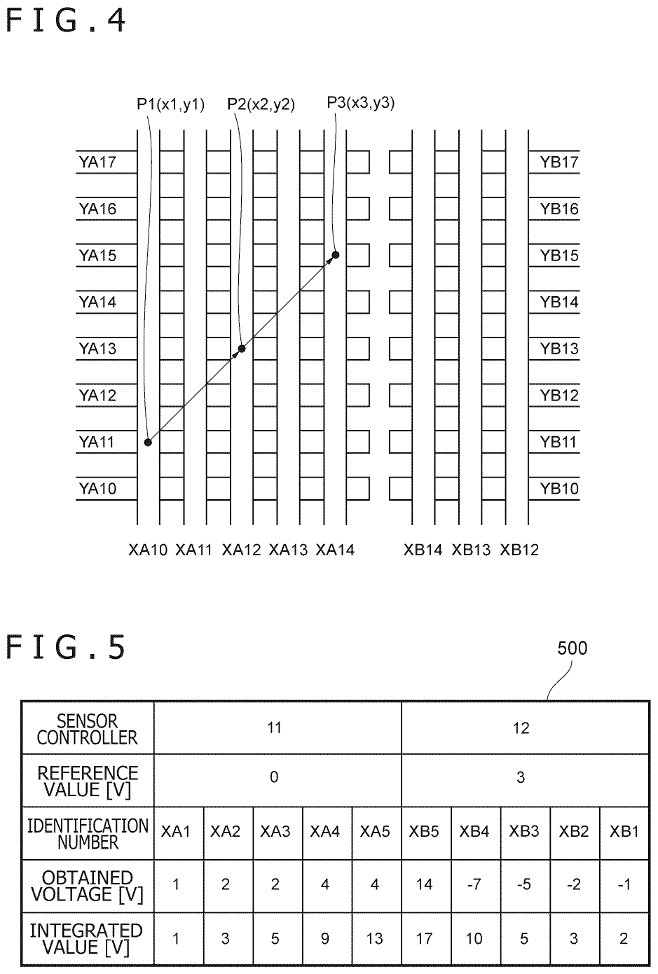

The coordinate information, the movement information, and the prediction information will now be described with reference to FIG. 4. FIG. 4 is a diagram designed to assist in explaining the prediction of the position detected by the position detecting device 1A. In FIG. 4, transmitting electrodes 101 are associated with YA1 to YAn as electrode identification numbers, transmitting electrodes 102 are associated with YB1 to YBn as electrode identification numbers, receiving electrodes 103 in the region A1 are associated with XA1 to XA14 as electrode identification numbers, and receiving electrodes 103 in the region A2 are associated with XB1 to XB14 as electrode identification numbers. In addition, in FIG. 4, a point P1 is a position indicated by the stylus 2 the previous time. A point P2 is a position indicated by the stylus 2 at the present time. A point P3 is a position that the first sensor controller 11 predicts to be indicated by the stylus 2 the next time.

The coordinate information is information indicating a position in the region A1 in which the plurality of transmitting electrodes 101 and the plurality of receiving electrodes 103 intersect each other. The coordinate information includes a coordinate in the X-axis direction from a reference position in the region A1 and a coordinate in the Y-axis direction from the reference position in the region A1. When the stylus 2 indicates the position of the point P2, the first sensor controller 11 determines which electrode of the transmitting electrodes 101 and the receiving electrodes 103 has detected the signal on the basis of the signals detected by the transmitting electrodes 101 and the receiving electrodes 103. The first sensor controller 11 calculates a maximal value of a voltage distribution in the region A1 with regard to the voltages of the respective signals transmitted from the electrodes detecting the signals on the basis of the determination. The first sensor controller 11 includes, as the coordinate information in the position information, a coordinate x2 in the X-axis direction and a coordinate y2 in the Y-axis direction corresponding to the calculated maximal value. Incidentally, also when the finger 3, rather than the stylus 2, indicates the position of the point P2, the first sensor controller 11 may similarly calculate a maximal value of a voltage distribution in the region A1 and include, as the coordinate information in the position information, the coordinate x2 in the X-axis direction and the coordinate y2 in the Y-axis direction corresponding to the calculated maximal value.

In addition, when the finger 3 indicates the position of the point P2, the first sensor controller 11 determines whether one of the transmitting electrodes 101 and the receiving electrodes 103 has detected the signal on the basis of the signals detected by the transmitting electrodes 101 and the receiving electrodes 103. The first sensor controller 11 calculates the gravity center of the voltage distribution in the region A1 on the basis of the voltage distribution with regard to the voltages of the respective signals transmitted from the electrodes detecting the signals on the basis of the determination. The first sensor controller 11 includes, as the coordinate information in the position information, the coordinate x2 in the X-axis direction and the coordinate y2 in the Y-axis direction corresponding to the calculated gravity center. Here, in calculating the gravity center, the first sensor controller 11 calculates a zeroth-order moment value and a first-order moment value in each of the X-axis direction and the Y-axis direction, and calculates the coordinates of the gravity center on the basis of the zeroth-order moment value from which the calculated first-order moment value is calculated. Incidentally, also when the stylus 2 indicates the position of the point P2, the first sensor controller 11 may calculate the gravity center of the voltage distribution in the region A1 on the basis of the voltage distribution and include, as the coordinate information in the position information, the coordinate x2 in the X-axis direction and the coordinate y2 in the Y-axis direction corresponding to the calculated gravity center.

Here, a method of calculating the zeroth-order moment value will now be described. The first sensor controller 11 sums, with regard to the X-axis direction, the voltage values of the signals transmitted from the receiving electrodes 103 detecting the signals, and calculates the summed value as the zeroth-order moment value with regard to the X-axis direction. In addition, the first sensor controller 11 sums, with regard to the Y-axis direction, the voltage values of the signals transmitted from the transmitting electrodes 101 detecting the signals, and calculates the summed value as the zeroth-order moment value with regard to the Y-axis direction.

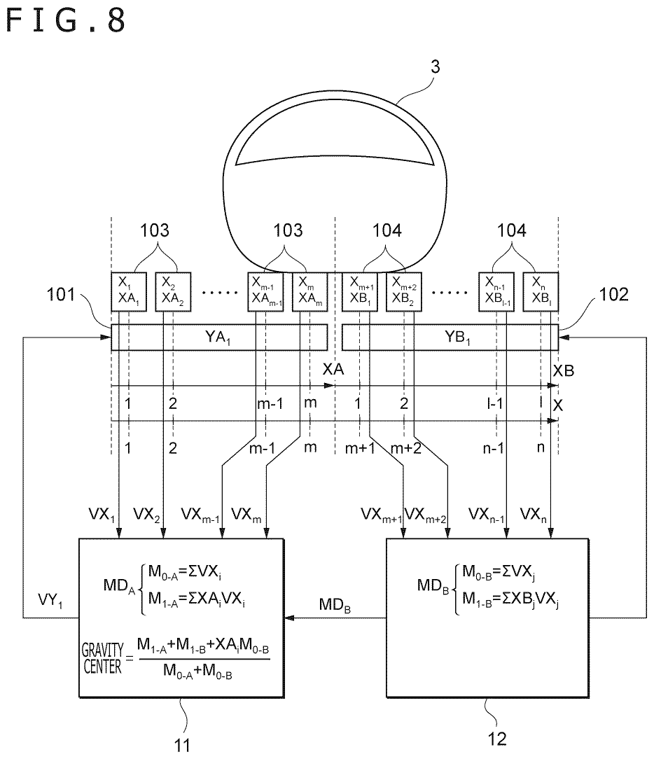

A method of calculating the first-order moment value will now be described. The first sensor controller 11 multiplies, with regard to the X-axis direction, the signals transmitted from the receiving electrodes 103 detecting the signals by the positions in the X-axis direction of the receiving electrodes 103 detecting the signals. Here, the positions in the X-axis direction may be the coordinates in the X-axis direction from a reference position in the region A1, or may be information regarding what ordinal numbers the positions in the X-axis direction correspond to when counted from a receiving electrode 103 serving as a reference. The first sensor controller 11 sums multiplication results for the respective receiving electrodes 103 detecting the signals, and calculates the summed value as the first-order moment value in the X-axis direction. In addition, the first sensor controller 11 multiplies, with regard to the X-axis direction, the signals transmitted from the transmitting electrodes 101 detecting the signals by the positions in the Y-axis direction of the transmitting electrodes 101 detecting the signals. Here, the positions in the Y-axis direction may be the coordinates in the Y-axis direction from a reference position in the region A1, or may be information regarding which ordinal numbers the positions in the Y-axis direction correspond to when counted from a transmitting electrode 101 serving as a reference. The first sensor controller 11 sums multiplication results for the transmitting electrodes 101 detecting the signals, and calculates the summed value as the first-order moment value in the Y-axis direction. Incidentally, a specific equation used in calculating the gravity center will be described later with reference to FIG. 8, and therefore a description thereof will be omitted here.

The first sensor controller 11 divides the calculated first-order moment value by the calculated zeroth-order moment value with regard to each of the X-axis direction and the Y-axis direction, and calculates the divided value as the coordinate of the gravity center in each of the X-axis direction and the Y-axis direction. The first sensor controller 11 includes the calculated coordinate of the gravity center as the coordinate information in the position information.

The movement information is information including a movement direction and a movement speed of the position indicated by the coordinate information. The movement direction included in the movement information is the direction of the point P2 indicated by the coordinate information generated by the first sensor controller 11 at the present time in a case where the point P1 indicated by the coordinate information generated by the first sensor controller 11 the previous time is set as a reference. In addition, the movement speed included in the movement information is the speed of a transition of the position indicated by the coordinate information per unit time. The first sensor controller 11 generates the movement information on the basis of a change between the past coordinate information and the present coordinate information. Specifically, the first sensor controller 11 calculates the movement direction by respectively subtracting the corresponding coordinates of a coordinate x1 in in the X-axis direction and a coordinate y1 in the Y-axis direction of the point P1 from the coordinate x2 in the X-axis direction and the coordinate y2 in the Y-axis direction of the point P2. In addition, the first sensor controller 11 calculates the movement speed by dividing a distance between the point P1 and the point P2 by a time elapsed from a time at which the first sensor controller 11 generates the coordinate information the previous time to a time at which the first sensor controller 11 generates the coordinate information at the present time during a predetermined time. In addition, the first sensor controller 11 includes the calculated movement direction and the calculated movement speed in the movement information.

The prediction information is information indicating a position to be reached by the position indicated by the coordinate information after the passage of a predetermined time. The prediction information includes a coordinate in the X-axis direction from the reference position in the region A1 and a coordinate in the Y-axis direction from the reference position in the region A1. The first sensor controller 11 calculates a coordinate x3 in the X-axis direction and a coordinate y3 in the Y-axis direction by adding the corresponding components in the X-axis direction and the Y-axis direction of the movement direction included in the generated movement information to the coordinate x2 in the X-axis direction and the coordinate y2 in the Y-axis direction included in the coordinate information generated at the present time. The first sensor controller 11 includes the calculated coordinates x3 and y3 as the prediction information in the position information.

### (Step SP18)

Returning to FIG. 11, the position detecting device 1A transmits the generated electrode information to the second sensor controller 12 by the first sensor controller 11. Then, the processing proceeds to the processing of step SP22.

### (Step SP22)

On the basis of the electrode information transmitted from the first sensor controller 11, the position detecting device 1A makes, by the second sensor controller 12, a setting for the processing of detecting a position in the region A2 of the sensor panel 10A based on signals detected from the transmitting electrodes 102 and the receiving electrodes 104.

Here, details of the setting for the detection processing will be described. By the second sensor controller 12, the position detecting device 1A, for example, makes the setting for the detection processing so as to increase a frequency of transmitting a signal for position detection from the transmitting electrodes 102 and the receiving electrodes 104 connected to the second sensor controller 12 via the signal lines 107 and 109 according to the electrode information transmitted from the first sensor controller 11. Specifically, the position detecting device 1A increases the frequency of transmitting the signal for position detection from the transmitting electrodes 102 and the receiving electrodes 104 in the second mode by shortening a cycle of selecting the modes from the first mode to the fourth mode by the second sensor controller 12. In addition, shortening the cycle of selecting the modes from the first mode to the fourth mode also increases a frequency of detection of a position indication by the finger 3 in the first mode.

In addition, the position detecting device 1A, for example, makes the setting by the second sensor controller 12 so as to transmit the signal for position detection from transmitting electrodes 102 and receiving electrodes 104 in the vicinity of the position indicated by the electrode information according to the electrode information transmitted from the first sensor controller 11. Details of the setting will now be described with reference to FIG. 4. By the first sensor controller 11, the position detecting device 1A generates the electrode information including the coordinate information indicating the position of the point P2 or the electrode identifying information, and transmits the electrode information to the second sensor controller 12. In the processing of step SP22, by the second sensor controller 12, the position detecting device 1A refers to the electrode information received from the first sensor controller 11, and obtains the coordinates x2 and y2 indicating the position of the point P2 or the electrode identification number YA13 of a transmitting electrode 101 and the electrode identification number XA12 of a receiving electrode 103. By the second sensor controller 12, the position detecting device 1A selects transmitting electrodes 102 having electrode identification numbers YB11 to YB15, which are transmitting electrodes 102 as a few electrodes (two electrodes in the present example) or within a predetermined distance in the upper edge direction and the lower edge direction from the obtained coordinate y2 or the obtained electrode identification number YA13. In addition, by the second sensor controller 12, the position detecting device 1A selects receiving electrodes 104 having electrode identification numbers XB13 to XB14, which are receiving electrodes 104 as a few electrodes (two electrodes in the present example) or within a predetermined distance in the right edge direction from a receiving electrode 104 at a left end in the region A2. Next, by the second sensor controller 12, the position detecting device 1A preferentially transmits the signal from the selected transmitting electrodes 102 and the selected receiving electrodes 104 when transmitting the signal from the electrodes in the first mode or the second mode. Incidentally, the position detecting device 1A may obtain, for example, the coordinates of the point P3 included in the prediction information in place of the point P2.

In addition, when the second sensor controller 12 receives the electrode information generated by the first sensor controller 11, the position detecting device 1A may ignore the order of switching from the first mode to the fourth mode and switch the mode of the second sensor controller 12. An example of the switching of the mode of the second sensor controller 12 will be described with reference to FIG. 12B. FIG. 12B is a diagram illustrating another example of the switching of the operation mode when the electrode information is transmitted and received.

At time t120, the operation mode of the first sensor controller 11 switches from the first mode to the second mode. At time t121, the operation mode of the second sensor controller 12 switches from the first mode to the second mode. At time t121, the second sensor controller 12 performs the processing of detecting a position indication by the stylus 2 by a global scanning setting for detecting the position indication by the stylus 2 in the entire region A2 in order from the second mode to the fourth mode. After time t121, the first sensor controller 11 detects a position indication in the region A1 by the stylus 2, generates the electrode information, and transmits the generated electrode information to the second sensor controller 12. During a period from time t121 to time t122, the second sensor controller 12 receives the electrode information transmitted from the first sensor controller 11. At time t122, because the second sensor controller 12 receives the electrode information to the effect that the stylus 2 is detected from the first sensor controller 11 during the period to time t122, the second sensor controller 12 switches the operation mode from the fourth mode to the second mode again rather than to the first mode. Further, at time t122, the second sensor controller 12 changes the setting for position detection from global scanning to local scanning, which transmits the signal for position detection from transmitting electrodes 102 and receiving electrodes 104 in the vicinity of the position indicated by the electrode information. Returning to FIG. 11, the processing proceeds to the processing of step SP26.

### (Step SP26)

By the second sensor controller 12, the position detecting device 1A converts shared information regarding the positions in the regions A1 and A2 into information regarding the positions in the region including the regions A1 and A2 on the sensor panel 10A, and transmits the converted information to another device in the apparatus 20 mounted with the position detecting device 1A. Then, the flow of the series of processing steps illustrated in FIG. 11 is ended.

The above description discussed details of a method of detecting a position on the sensor panel 10A in the first sensor controller 11 and the second sensor controller 12. Incidentally, in order to increase the accuracy of receiving the signals detected by the transmitting electrodes 101 and 102 and the receiving electrodes 103 and 104, the first sensor controller 11 and the second sensor controller 12 may receive the signals from the transmitting electrodes 101 and 102 and the receiving electrodes 103 and 104 as differential signals. In a case where the first sensor controller 11 and the second sensor controller 12 receive the signals from the transmitting electrodes 101 and 102 and the receiving electrodes 103 and 104 as differential signals, the first sensor controller 11 and the second sensor controller 12 convert the received signals into actual voltage values by performing an integral operation on the received signals, and generate the electrode information on the basis of the converted voltage values. Here, referring to FIG. 5, processing of the integral operation by the first sensor controller 11 and the second sensor controller 12 will now be described.

FIG. 5 is a diagram designed to assist in explaining the integral operation on the signals detected by the transmitting electrodes 101 and 102 and the receiving electrodes 103 and 104. Incidentally, while, in the present example, a description of detection processing using the receiving electrodes 103 and 104 will be provided, similar processing is performed also in the case of the transmitting electrodes 101 and 102.

In a case where the signals detected by the receiving electrodes 103 and 104 are received as differential signals, the first sensor controller 11, for example, calculates a potential difference of a signal detected by one receiving electrode 103 with respect to a signal detected by a receiving electrode 103 adjacent thereto on the left edge side by a differential input circuit or the like, and receives the calculated potential difference as the signal detected by the one receiving electrode 103. Incidentally, in a case where the one receiving electrode 103 is a receiving electrode 103 at the left end in the region A1, a potential difference with respect to a predetermined reference value is calculated, and the calculated potential difference is received as the signal detected by the one receiving electrode 103. Next, as illustrated in a table 500, for each of the obtained signals, the first sensor controller 11 associates the obtained voltage with information regarding which of the sensor controllers has obtained the signal, the reference value, and information for identifying the receiving electrode 103 (an electrode identification number, a coordinate, an array indicating what ordinal number the receiving electrode 103 corresponds to when counted from the receiving electrode 103 at the left end in the region A1, or the like).

The first sensor controller 11 performs the integral operation in order from the obtained voltage corresponding to the receiving electrode 103 located at the left end in the region A1. Specifically, first, the first sensor controller 11 adds 0 [V] as a reference value to 1 [V] as an obtained voltage corresponding to the receiving electrode 103 at the left end of the region A1, and stores 1 [V], which is a result of the addition, as an integrated value of the receiving electrode 103 at the left end. Next, the first sensor controller 11 adds 1 [V] as the integrated value corresponding to the receiving electrode 103 at the left end of the region A1 to 2 [V] as an obtained voltage corresponding to a second receiving electrode 103 from the left end of the region A1, and stores 3 [V], which is a result of the addition, as an integrated value of the second receiving electrode 103 from the left end. Further, the first sensor controller 11 adds 3 [V] as the integrated value corresponding to the second receiving electrode 103 from the left end of the region A1 to 2 [V] as an obtained voltage corresponding to a third receiving electrode 103 from the left end of the region A1, and stores 5 [V], which is a result of the addition, as an integrated value of the second receiving electrode 103 from the left end. The first sensor controller 11 thereafter similarly repeats the operation until reaching a receiving electrode 103 at the right end of the region A1, and thereby calculates the integrated values of the respective receiving electrodes 103 in the region A1. Then, the first sensor controller 11 generates the electrode information by using the calculated results of the integral operation as the voltage values of the signals actually detected by the receiving electrodes 103.

Incidentally, the second sensor controller 12 also performs processing similar to that of the first sensor controller 11. The processing is the same as the processing performed by the first sensor controller 11 except that the predetermined reference value is different and the integral operation is performed for the receiving electrodes 104 in the region A2. Specifically, first, the second sensor controller 12 adds 3 [V] as a reference value to 14 [V] as an obtained voltage corresponding to a receiving electrode 104 at the left end of the region A2, and stores 17 [V], which is a result of the addition, as an integrated value of the receiving electrode 104 at the left end. Next, the second sensor controller 12 adds 17 [V] as the integrated value corresponding to the receiving electrode 104 at the left end of the region A2 to −7 [V] as an obtained voltage corresponding to a second receiving electrode 104 from the left end of the region A2, and stores 10 [V], which is a result of the addition, as an integrated value of the second receiving electrode 104 from the left end. Further, the second sensor controller 12 adds 10 [V] as the integrated value corresponding to the second receiving electrode 104 from the left end of the region A2 to −5 [V] as an obtained voltage corresponding to a third receiving electrode 104 from the left end of the region A2, and stores 5 [V], which is a result of the addition, as an integrated value of the second receiving electrode 104 from the left end. The second sensor controller 12 thereafter similarly repeats the operation until reaching a receiving electrode 104 at the right end of the region A2, and thereby calculates the integrated values of the respective receiving electrodes 104 in the region A2.

Next, referring to FIG. 7, another example of the detection of a position indication by the stylus 2 in the first mode will now be described. FIG. 7 is a graph illustrating relation between the coordinates of the receiving electrodes 103 and 104 and obtained voltages. In the present example, a description will be made with regard to the receiving electrodes 103 and 104. For the signals detected by the receiving electrodes 103 in the region A1, the first sensor controller 11 associates the obtained voltages of the respective signals with the electrode identifying information related to the receiving electrodes 103 detecting the signals, and generates electrode information so as to include the obtained voltages and the electrode identifying information associated with each other. The first sensor controller 11 transmits the generated electrode information to the second sensor controller 12. In addition, for the signals detected by the receiving electrodes 104 in the region A2, the second sensor controller 12 associates the obtained voltages of the respective signals with the electrode identifying information related to the receiving electrodes 104 detecting the signals.

The second sensor controller 12 refers to the obtained voltages of the respective signals in the region A2 and the electrode identifying information as well as the obtained voltages of the respective signals in the region A1 and the electrode identifying information that are included in the electrode information transmitted from the first sensor controller 11. The second sensor controller 12 sorts the obtained voltages and the electrode identifying information according to distances of the receiving electrodes 103 and 104 indicated by the electrode identifying information corresponding to the respective signals from, for example, the left end in the region including the regions A1 and A2 of the sensor panel 10A. Next, for the obtained voltages and the electrode identifying information that have been sorted, the second sensor controller 12 generates an approximate curve in a case where an X-axis indicates distance from the left end in the region including the regions A1 and A2, and a Y-axis indicates the obtained voltages. The second sensor controller 12 calculates a maximal value of the approximate curve on the basis of the generated approximate curve. The second sensor controller 12 detects an X-axis value of the calculated maximal value as an X-axis coordinate of the position indicated on the sensor panel 10A by the finger 3. For example, in FIG. 7, as illustrated in a graph 700, the X-axis value corresponding to the maximal value of the obtained voltages is 6, and therefore the value of 6 is detected as the X-axis coordinate. Incidentally, the second sensor controller 12 performs similar processing for the transmitting electrodes 101 and 102, and detects an X-axis value of a maximal value calculated by the processing as a Y-axis coordinate of the position indicated on the sensor panel 10A by the finger 3.

It is to be noted that, while the second sensor controller 12 uses, for example, a B-spline curve as the kind of the generated approximate curve, other embodiments are not limited to this. The second sensor controller 12 may generate an interpolation curve (a one-dimensional Lagrange complementation curve, a cubic spline interpolation curve, a Bezier curve, a quadratic function having an upwardly convex shape, or the like) in place of the approximate curve.

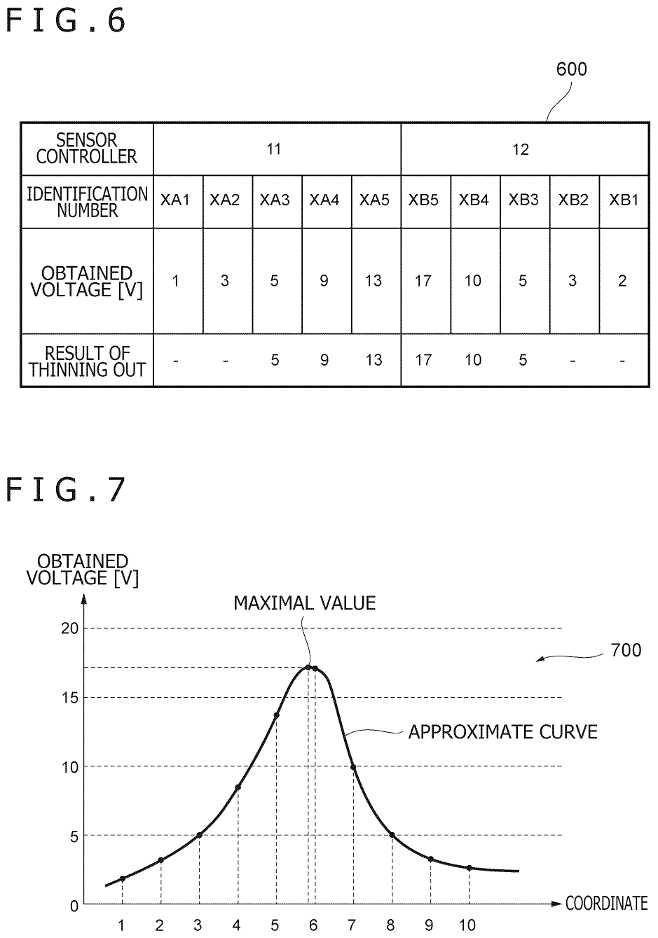

Incidentally, in generating the electrode information, in order to reduce the amount of data communication by transmission and reception of the electrode information, the first sensor controller 11 and the second sensor controller 12 may generate the electrode information after thinning out unnecessary signals among the signals detected by the transmitting electrodes 101 and 102 and the receiving electrodes 103 and 104. Here, referring to FIG. 6, processing of integral operation by the first sensor controller 11 and the second sensor controller 12 will now be described. FIG. 6 is a diagram designed to assist in explaining a thinning-out operation on the signals detected by the transmitting electrodes 101 and 102 and the receiving electrodes 103 and 104. While detection processing using the receiving electrodes 103 and 104 will be described here, similar processing is also performed in the case of the transmitting electrodes 101 and 102.

As illustrated in a table 600, for each of the obtained signals, the first sensor controller 11 associates the obtained voltage with information regarding which of the sensor controllers has obtained the signal and information for identifying the receiving electrode 103 (an electrode identification number, a coordinate, an array indicating what ordinal number the receiving electrode 103 corresponds to when counted from the receiving electrode 103 at the left end in the region A1, or the like). Next, the first sensor controller 11 determines for each signal whether or not the voltage value of the signal is equal to or higher than a predetermined second reference value. In FIG. 6, the second reference value is 5 [V]. The first sensor controller 11 generates the electrode information so as to associate, with each other, the electrode identifying information of receiving electrodes 103 for which the determination is a positive determination, the voltage values of the signals detected by the receiving electrodes 103, and information regarding which of the sensor controllers the receiving electrodes 103 correspond to. The first sensor controller 11 transmits the generated electrode information to the second sensor controller 12.

Incidentally, in the thinning-out processing on the signals detected by the transmitting electrodes 101 and the receiving electrodes 103, the first sensor controller 11 may compare the obtained voltages with each other and select only a predetermined number of obtained voltages in decreasing order of voltage values thereof, the predetermined number being determined in advance. In FIG. 6, the predetermined number determined in advance is 3. In this case, the first sensor controller 11 sets, as the electrode information, the selected obtained voltages, information regarding which of the sensor controllers the electrodes corresponding to the obtained voltages correspond to, and information for identifying the receiving electrodes 103. The first sensor then transmits the electrode information to the second sensor controller 12.

Next, referring to FIG. 8, a description will be made of position detection of the position detecting device 1A in a case where the finger 3 performs a position indication on the sensor panel 10A so as to straddle the regions A1 and A2. FIG. 8 is a diagram designed to assist in explaining position detection in a case where a position indication by the finger 3 straddles the left and right regions A1 and A2 on the sensor panel 10A. In FIG. 8, a total of n receiving electrodes 103 and 104 are provided on the sensor panel 10A. In addition, the widths in the X-axis direction of the regions A1 and A2 are XA and XB, respectively. In addition, m receiving electrodes 103 are provided in the region A1, and are respectively associated with XA₁, . . . , XAₘ as coordinates in the X-axis direction with the left edge side in the region A1 as a reference point. In addition, 1 receiving electrodes 104 are provided in the region A2, and are respectively associated with XB₁, . . . , XB₁ as coordinates in the X-axis direction with the left edge side in the region A2 as a reference point. In addition, in FIG. 8, the receiving electrodes 103 and 104 are associated with X₁, X₂, . . . , Xₙ as coordinates in the X-axis direction with the left edge side as a reference point in the region including the regions A1 and A2. Incidentally, the present example will describe a case where the second sensor controller 12 generates electrode information, and transmits the generated electrode information to the first sensor controller 11. Similar processing is performed in a case where the first sensor controller 11 generates electrode information and transmits the generated electrode information to the second sensor controller 12. A description thereof will therefore be omitted.

The second sensor controller 12 calculates a zeroth-order moment value M_{0-B} related to the receiving electrodes 104 in the region A2 by summing the potential VXⱼ of a signal transmitted from a transmitting electrode 102 and received by a jth receiving electrode 104 from the left provided in the region A2 (that is, VXₘ₊₁, VXₘ₊₂, . . . , VXₙ). Specifically, the second sensor controller 12 calculates the zeroth-order moment value M_{0-B} related to the receiving electrodes 104 in the region A2 by substituting the voltage value of the potential VXⱼ of the signal into a relational equation: M_{0-B}=ΣVXⱼ [Equation 1]. In addition, the second sensor controller 12 calculates a first-order moment value M_{1-B} related to the receiving electrodes 104 in the region A2 by multiplying the potential VXⱼ of the signal by a coordinate XBⱼ in the X-axis direction indicating the jth receiving electrode 104 from the left in the region A2 for each of the receiving electrodes 104 in the region A2, and further summing each multiplication result. Specifically, the second sensor controller 12 calculates the first-order moment value M_{1-B} related to the receiving electrodes 104 in the region A2 by substituting the potential VXⱼ of the signal and the coordinate XBⱼ into a relational equation: M_{0-B}=Σ(XBⱼ×VXⱼ) [Equation 2]. The second sensor controller 12 generates electrode information MD_{B} so as to include the calculated zeroth-order moment value M_{0-B} and the calculated first-order moment value M_{1-B}, and transmits the generated electrode information MD_{B} to the first sensor controller 11.

The first sensor controller 11 calculates a zeroth-order moment value M_{0-A} related to the receiving electrodes 103 in the region A1 by summing the potential VXᵢ of a signal transmitted from a transmitting electrode 101 and received by an ith receiving electrode 103 from the right provided in the region A1 (that is, VX₁, VX₂, . . . , VXₘ). The signal is a signal based on a capacitance between the transmitting electrode 101 and the receiving electrode 103. Specifically, the first sensor controller 11 calculates the zeroth-order moment value M_{0-A} related to the receiving electrodes 103 in the region A1 by substituting the voltage value of the potential VXᵢ of the signal into a relational equation: M_{0-A}=2VXᵢ [Equation 3]. In addition, the first sensor controller 11 calculates a first-order moment value M_{1-A} related to the receiving electrodes 103 in the region A1 by multiplying the potential VXᵢ of the signal by a coordinate XAⱼ in the X-axis direction indicating the ith receiving electrode 103 from the left in the region A1 for each of the receiving electrodes 103 provided in the region A1, that is, for each of the receiving electrodes 103 in the region A1 and further summing each multiplication result. Specifically, the first sensor controller 11 calculates the first-order moment value M_{1-A} related to the receiving electrodes 103 in the region A1 by substituting the potential VXᵢ of the signal and the coordinate XAᵢ into a relational equation: M_{0-A}=(ΣXAᵢ×VXᵢ) [Equation 4].

The first sensor controller 11 receives the electrode information MD_{B} transmitted from the second sensor controller 12, and calculates the gravity center of the signals detected by the respective receiving electrodes 103 and 104 on the basis of the zeroth-order moment value M_{0-A} and the first-order moment value M_{1-A} in the region A1 and the zeroth-order moment value M_{0-B} and the first-order moment value M_{1-B} in the region A2. The first sensor controller 11 multiplies the width XA in the X-axis direction of the region A1 by the zeroth-order moment value M_{0-A} in the region A2, and adds, to a result of the multiplication, the first-order moment value M_{1-A} in the region A1 and the first-order moment value M_{1-B} in the region A2. Further, the first sensor controller 11 divides a result of the addition by a result of summing the zeroth-order moment value M_{0-A} in the region A1 and the zeroth-order moment value M_{0-B} in the region A2, and calculates a result of the division as the gravity center of the signals detected by the respective receiving electrodes 103. Specifically, the first sensor controller 11 calculates the gravity center of the signals detected by the respective receiving electrodes 103 and 104 by substituting the zeroth-order moment values M_{0-A} and M_{0-B}, the first-order moment values M_{1-A} and M_{1-B}, and the coordinate XAi into a relational equation: Gravity Center=(M_{1-A}+M_{1-B}+XAᵢ×M_{0-B})/(M_{0-A}+M_{0-B}) [Equation 5].

### Effects

As described above, in the first embodiment, the position detecting device 1A includes a sensor panel 10A having a receiving electrode 103 (first receiving electrode), a transmitting electrode 101 (first transmitting electrode) disposed so as to perpendicularly intersect the receiving electrode 103, a transmitting electrode 102 (second transmitting electrode) having one end adjacent to one end of the transmitting electrode 101 and disposed so as to extend in a direction parallel with the transmitting electrode 101, and a receiving electrode 104 (second receiving electrode) disposed so as to perpendicularly intersect the transmitting electrode 102. The position detecting device 1A further includes a first sensor controller 11. The first sensor controller 11 detects a position on the sensor panel 10A on the basis of signals detected by the transmitting electrode 101 and the receiving electrode 103, generates electrode information related to the detection, and transmits the electrode information The position detecting device further includes a second sensor controller 12 that, on the basis of the electrode information transmitted from the first sensor controller 11, makes a setting for processing of detecting a position on the sensor panel 10A on the basis of signals detected from the transmitting electrode 102 and the receiving electrode 104.

According to this configuration, in the position detecting device 1A, the transmitting electrodes 101 and 102 among the transmitting electrodes 101 and 102 and the receiving electrodes 103 and 104 on the sensor panel 10A are arranged as respective different electrodes on the sensor panel 10A. Capacitances accompanying the transmitting electrodes 101 and 102 are therefore suppressed. That is, in the position detecting device 1A, because the transmitting electrodes 101 and 102 are respective different electrodes, an accompanying capacitance per electrode is reduced as compared with a case where the transmitting electrode 101 and the transmitting electrode 102 having the same coordinate in the Y-axis direction are formed as one electrode. Hence, the position detecting device 1A can suppress a decrease in accuracy of position detection based on the capacitances accompanying the transmitting electrodes 101 and 102. The position detecting device 1A can therefore detect a position on the sensor panel 10A with high accuracy.

In addition, in the first embodiment, on the basis of the signals detected by the transmitting electrode 101 (first transmitting electrode) and the receiving electrode 103 (first receiving electrode), the first sensor controller 11 generates detection information indicating whether the signals are detected, and the first sensor controller 11 generates the electrode information including the generated detection information.

According to this configuration, the position detecting device 1A shares, between the first sensor controller 11 and the second sensor controller 12, the information regarding whether or not the signals are detected by the transmitting electrode 101 and the receiving electrode 103. Hence, the position detecting device 1A can detect a position on the sensor panel 10A with higher accuracy.

In addition, in the first embodiment, a plurality of transmitting electrodes 101 and a plurality of receiving electrodes 103 are arranged on the sensor panel 10A, and the first sensor controller 11 generates position information indicating a position in a region A1 in which the plurality of transmitting electrodes 101 and the plurality of receiving electrodes 103 intersect each other on the basis of signals detected by the transmitting electrodes 101 (first transmitting electrodes) and the receiving electrodes 103 (first receiving electrodes), and generates the electrode information including the generated position information.

According to this configuration, the position detecting device 1A shares, between the first sensor controller 11 and the second sensor controller 12, the position information indicating the position in the region A1 in which the transmitting electrodes 101 and the receiving electrodes 103 intersect each other. Hence, the position detecting device 1A can detect the position on the sensor panel 10A with higher accuracy.

In addition, in the first embodiment, the position information includes electrode identifying information indicating which of the plurality of transmitting electrodes 101 (first transmitting electrodes) and the plurality of receiving electrodes 103 (first receiving electrodes) has detected a signal.

According to this configuration, the position detecting device 1A shares, between the first sensor controller 11 and the second sensor controller 12, the electrode identifying information regarding which electrode of the transmitting electrodes 101 and the receiving electrodes 103 has detected a signal. Hence, the position detecting device 1A can detect a position on the sensor panel 10A with higher accuracy.

In addition, in the first embodiment, the position information includes coordinate information indicating the position in the region A1 in which the plurality of transmitting electrodes 101 (first transmitting electrodes) and the plurality of receiving electrodes 103 (first receiving electrodes) intersect each other.

According to this configuration, the position detecting device 1A shares the coordinate information indicating the position in the region A1 between the first sensor controller 11 and the second sensor controller 12. Hence, the position detecting device 1A can detect the position on the sensor panel 10A with higher accuracy.

In addition, in the first embodiment, the first sensor controller 11 generates movement information including a movement direction and a movement speed of the position indicated by the coordinate information on the basis of a change between past coordinate information and present coordinate information, and includes the generated movement information in the position information.

According to this configuration, the position detecting device 1A shares the movement information related to a change in the coordinate information between the first sensor controller 11 and the second sensor controller 12. Hence, the position detecting device 1A can also detect a change in the detected position on the sensor panel 10A with high accuracy.

In addition, in the first embodiment, the first sensor controller 11 generates prediction information indicating a position to be reached by the position indicated by the coordinate information after passage of a predetermined time on the basis of the movement information, and includes the generated prediction information in the position information.

According to this configuration, the position detecting device 1A shares, between the first sensor controller 11 and the second sensor controller 12, the prediction information related to the prediction of the position at which a signal is likely to be hereafter detected on the sensor panel 10A. Hence, the position detecting device 1A can predict the position likely to be detected on the sensor panel 10A with high accuracy.

In addition, in the first embodiment, a plurality of transmitting electrodes 101 and 102 and a plurality of receiving electrodes 103 and 104 are arranged on the sensor panel 10A, and the second sensor controller 12 makes the setting so as to transmit a signal for position detection from transmitting electrodes 102 in a vicinity of the position indicated by the electrode information according to the electrode information transmitted from the first sensor controller 11.

According to this configuration, the position detecting device 1A transmits the signal for position detection from the electrodes in the vicinity of the position indicated by the electrode information, and can therefore perform the position detection in the region A2 with higher accuracy.

In addition, in the first embodiment, the second sensor controller 12 makes the setting, according to the electrode information transmitted from the first sensor controller 11, so as to increase frequency of signal transmission for position detection from the transmitting electrode 102 connected to the second sensor controller 12 via signal lines 107 and 109.

According to this configuration, the position detecting device 1A increases the frequency of the position detection in the region A2 on the basis of reception of the electrode information, and can therefore perform the position detection in the region A2 with higher accuracy.

In addition, in the first embodiment, a plurality of transmitting electrodes 101 and a plurality of receiving electrodes 103 are arranged on the sensor panel 10A, and the first sensor controller 11 performs an integral operation on each of signal detected by the transmitting electrodes 101 (first transmitting electrodes) and the receiving electrodes 103 (first receiving electrodes) with a corresponding array of the transmitting electrodes 101 and the receiving electrodes 103 as a reference. The first sensor controller then generates the electrode information so as to include a result of the integral operation.

According to this configuration, the position detecting device 1A can detect a position on the sensor panel 10A with high accuracy also in a case where the integral operation is necessary. This includes a case, for example, where the signals detected by the transmitting electrodes 101 and the receiving electrodes 103 are received as differential signals.

In addition, in the first embodiment, a plurality of transmitting electrodes 101 and a plurality of receiving electrodes 103 are arranged on the sensor panel 10A, and the first sensor controller 11 determines, for each of signal detected by the transmitting electrodes 101 (first transmitting electrodes) and the receiving electrodes 103 (first receiving electrodes), whether or not a voltage value of the signal is equal to or higher than a second reference value. The first sensor controller 11 then generates the electrode information so as to associate, with each other, electrode identifying information of a transmitting electrode 101 and a receiving electrode 103 for which the determination is a positive determination and the voltage values of the signals detected by the transmitting electrode 101 and the receiving electrode 103.

According to this configuration, the position detecting device 1A, for example, generates the electrode information with regard to electrodes corresponding to signals having voltage values equal to or higher than the second reference value among the transmitting electrodes 101 and the receiving electrodes 103. Hence, the position detecting device 1A suppresses an amount of communication of the electrode information when transmitting the electrode information from the first sensor controller 11 to the second sensor controller 12. The position detecting device 1A can therefore reduce power consumption.

In addition, in the first embodiment, a plurality of transmitting electrodes 101 and 102 and a plurality of receiving electrodes 103 and 104 are arranged on the sensor panel 10A, and the second sensor controller 12 detects a maximal value of voltage values of the respective signals as the position on the sensor panel 10A based on the electrode information and signals detected by the transmitting electrodes 102 and the receiving electrodes 104 connected to the second sensor controller 12 via signal lines 107 and 109.

According to this configuration, the position detecting device 1A detects the maximal value of the voltage values of the respective signals as the position on the sensor panel 10A, and can therefore detect the position on the sensor panel 10A easily without requiring a complex operation.

In addition, in the first embodiment, a plurality of transmitting electrodes 101 and a plurality of receiving electrodes 103 are arranged on the sensor panel 10A, and the first sensor controller 11 calculates each of a zeroth-order moment value and a first-order moment value for the transmitting electrodes 101 (first transmitting electrodes) and the receiving electrodes 103 (first receiving electrodes) on the basis of voltage values of respective signals detected by the transmitting electrodes 101 and the receiving electrodes 103 and distances of the transmitting electrodes 101 and the receiving electrodes 103 detecting the signals from a reference position. The first sensor controller 11 then generates the electrode information so as to include the calculated zeroth-order moment value and the calculated first-order moment value.

According to this configuration, the position detecting device 1A calculates the zeroth-order moment value and the first-order moment value and includes the two values in the electrode information. Thus, the amount of communication of the electrode information from the first sensor controller 11 to the second sensor controller 12 is suppressed. Hence, the position detecting device 1A can detect a position on the sensor panel 10A with high accuracy and low power consumption even in a case where a plurality of positions are indicated on the sensor panel 10A.

In addition, in the first embodiment, a plurality of transmitting electrodes 102 and a plurality of receiving electrodes 104 are arranged on the sensor panel 10A, and the second sensor controller 12 calculates each of a zeroth-order moment value and a first-order moment value for the transmitting electrodes 102 (second transmitting electrodes) and the receiving electrodes 104 (second receiving electrodes) on the basis of voltage values of respective signals detected by the transmitting electrodes 102 and the receiving electrodes 104 and distances of the transmitting electrodes 102 and the receiving electrodes 104 detecting the signals from a reference position. The second sensor controller 12 then calculates a gravity center of a detected region on the sensor panel 10A detected by the transmitting electrodes 101 (first transmitting electrodes), the transmitting electrodes 102 (second transmitting electrodes), the receiving electrodes 103 (first receiving electrodes), and the receiving electrodes 104 (second receiving electrodes) on the basis of the calculated zeroth-order moment value and the calculated first-order moment value and the zeroth-order moment value and the first-order moment value included in the electrode information. The second sensor controller 12 then detects the calculated gravity center as the position on the sensor panel 10A.

According to this configuration, the position detecting device 1A calculates the gravity center of the detected region on the sensor panel 10A on the basis of the zeroth-order moment value and the first-order moment value in the region A1 calculated by the first sensor controller 11 and the zeroth-order moment value and the first-order moment value in the region A2 calculated by the second sensor controller 12. Hence, the position detecting device 1A can detect the position on the sensor panel 10A with high accuracy and low power consumption even in a case where, for example, the finger 3 indicates a position so as to straddle the regions A1 and A2 on the sensor panel 10A.

In addition, in the first embodiment, the sensor panel 10A includes a receiving electrode 103 (first receiving electrode), a transmitting electrode 101 (first transmitting electrode) disposed so as to perpendicularly intersect the receiving electrode 103, a transmitting electrode 102 (second transmitting electrode) disposed so as to extend in a direction parallel with the transmitting electrode 101 such that a first end of the transmitting electrode 102 is adjacent to a first end of the transmitting electrode 101, a receiving electrode 104 (second receiving electrode) disposed so as to perpendicularly intersect the transmitting electrode 102, a signal line 106 (first signal line) having a first end connected to a second end of the transmitting electrode 101, a signal line 107 (second signal line) having a first end connected to a second end of the transmitting electrode 102, a signal line 108 (third signal line) having a first end connected to a first end of the receiving electrode 103 and disposed between the signal line 106 and the signal line 107, and a signal line 109 (fourth signal line) having a first end connected to a first end of the receiving electrode 104 and disposed between the signal line 107 and the signal line 108.

According to this configuration, the transmitting electrodes 101 and 102 among the transmitting electrodes 101 and 102 and the receiving electrodes 103 and 104 on the sensor panel 10A are arranged as respective different electrodes on the sensor panel 10A. Hence, the sensor panel 10A can suppress a decrease in accuracy of position detection based on capacitances accompanying the transmitting electrodes 101 and 102.

In addition, in the first embodiment, the first ends of the transmitting electrodes 101 and 102 are formed in a comb tooth shape, and the first end of the transmitting electrode 101 is formed so as to have a comb tooth-shaped recessed portion meshing with a comb tooth-shaped projecting portion of the first end of the transmitting electrode 102 and have a comb tooth-shaped projecting portion meshing with a comb tooth-shaped recessed portion of the first end of the transmitting electrode 102.

According to this configuration, the first ends of the transmitting electrodes 101 and 102 are formed such that the recessed portions and the projecting portions thereof mesh with each other. A gap formed between the transmitting electrodes 101 and 102 is therefore reduced. Hence, the sensor panel 10A can further suppress a decrease in the accuracy of the position detection. In addition, when the position detecting device 1A detects a signal generated by contact of the stylus 2 or the finger 3 in the vicinity of the boundary between the regions A1 and A2, the position detecting device 1A can detect the signal by the first sensor controller 11 and the second sensor controller 12 at the same coordinate in the X-axis direction and the same signal strength.

### Second Embodiment

A second embodiment will now be described.

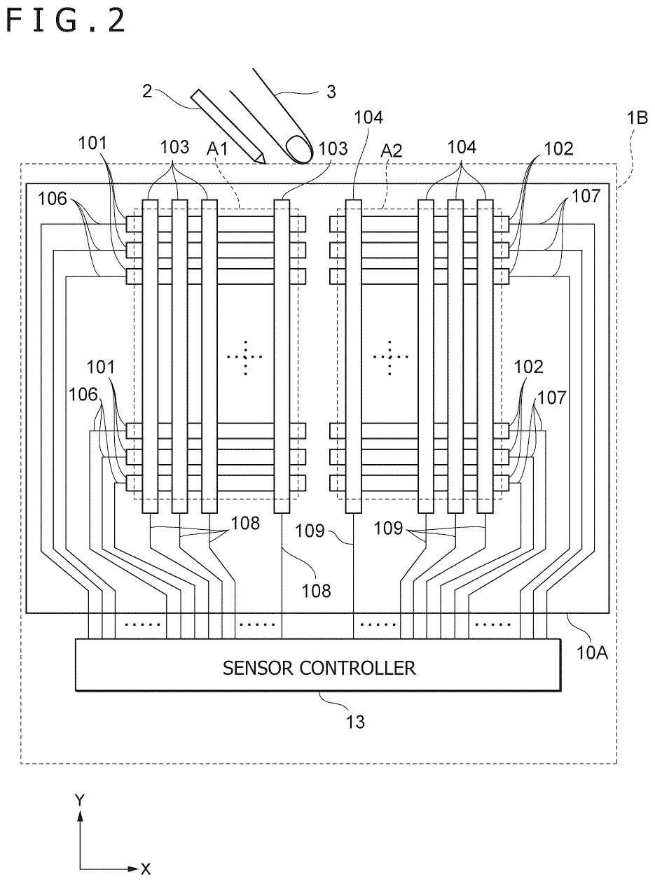

FIG. 2 is a diagram illustrating an example of a position detecting device 1B according to the second embodiment. A main part of the position detecting device 1B is configured by including, for example, a sensor panel 10A and a sensor controller 13. That is, the position detecting device 1B is configured to detect positions indicated by the stylus 2 and the finger 3 of the user and perform various types of information processing according to a result of the detection by one sensor controller 13 in place of the first sensor controller 11 and the second sensor controller 12 in the position detecting device 1A.

First ends of each respective signal line 106 are connected to second ends of corresponding transmitting electrodes 101 among a plurality of transmitting electrodes 101, and second ends of signal lines 106 are connected to the sensor controller 13 from the lower edge side of the sensor panel 10A. Incidentally, the second ends of the signal lines 106 are provided on the left edge side of the second ends of signal lines 108 on the sensor panel 10A.

First ends of each respective signal line 107 are connected to second ends of corresponding transmitting electrodes 102 among a plurality of transmitting electrodes 102, and second ends of signal lines 107 are connected to the sensor controller 13 from the lower edge side of the sensor panel 10A. Incidentally, the second ends of the signal lines 107 are provided on the right edge side of second ends of signal lines 109 on the sensor panel 10A.

First ends of each respective signal line 108 are connected to second ends of corresponding receiving electrodes 103 among a plurality of receiving electrodes 103, and the second ends of the signal lines 108 are connected to the sensor controller 13 from the lower edge side of the sensor panel 10A. Incidentally, the second ends of the signal lines 108 are provided on the right edge side of the second ends of the signal lines 106 and on the left edge side of the second ends of the signal lines 109 on the sensor panel 10A. That is, the signal lines 108 are provided between the signal lines 106 and the signal lines 109 in the X-axis direction.

First ends of each respective signal line 109 are connected to second ends of corresponding receiving electrodes 104 among a plurality of receiving electrodes 104, and the second ends of the signal lines 109 are connected to the sensor controller 13 from the lower edge side of the sensor panel 10A. Incidentally, the second ends of the signal lines 109 are provided on the right edge side of the second ends of the signal lines 108 and on the left edge side of the second ends of the signal lines 107 on the sensor panel 10A. That is, the signal lines 109 are provided between the signal lines 107 and the signal lines 108 in the X-axis direction.

The sensor controller 13 is functionally configured to be able to detect positions indicated by the stylus 2 and the finger 3 of the user on the sensor panel 10A and receive a data signal transmitted by the stylus 2 by reading and executing a program stored in a memory by a processor. The sensor controller 13 detects an indicated position in a region A1 on the sensor panel 10A on the basis of signals detected from the transmitting electrodes 101 and the receiving electrodes 103. In addition, the sensor controller 13 detects an indicated position in a region A2 on the sensor panel 10A on the basis of signals detected from the transmitting electrodes 102 and the receiving electrodes 104.

Similar to the first sensor controller 11 and the second sensor controller 12 in the first embodiment, the sensor controller 13 has an idle mode and an active mode with first to fourth modes, and controls the position detecting device 1B while selecting, in order, these four kinds of modes in the active mode. Details of operation of the sensor controller 13 in each mode are as described in the first embodiment, and will therefore be omitted.

In addition, the sensor controller 13 receives signals detected by the transmitting electrodes 101 and the receiving electrodes 103. The reception of the signals is performed in the first mode and the third mode in a cycle in which the sensor controller 13 selects the modes from the first mode to the fourth mode in order. Next, the sensor controller 13 generates electrode information regarding a position on the sensor panel 10A on the basis of the signals received from the transmitting electrodes 101 and the receiving electrodes 103. Incidentally, the electrode information is as described in the first embodiment, and therefore a description thereof will be omitted.

On the basis of the generated electrode information, the sensor controller 13 makes a setting for the processing of detecting a position in the region A2 of the sensor panel 10A based on the signals detected from the transmitting electrodes 102 and the receiving electrodes 104. Further, the sensor controller 13 converts information regarding the detected positions in the regions A1 and A2 into information regarding the positions in the region including the regions A1 and A2 on the sensor panel 10A. The sensor controller 13 then transmits the converted information to another device in the apparatus 20 mounted with the position detecting device 1A.

Details of a concrete operation of the setting for the detection processing in the second embodiment will be described. The sensor controller 13 makes the setting for the detection processing so as to increase a frequency of signal transmission for position detection from the transmitting electrodes 102 and the receiving electrodes 104 according to the electrode information. Specifically, the sensor controller 13 increases the frequency of signal transmission for position detection from the transmitting electrodes 102 and the receiving electrodes 104 in the second mode by shortening a cycle of selecting the modes from the first mode to the fourth mode. In addition, shortening the cycle of selecting the modes from the first mode to the fourth mode also increases a frequency of detection of a position indication by the finger 3 in the first mode.

In addition, the sensor controller 13 makes the setting so as to transmit the signal for position detection from transmitting electrodes 102 and receiving electrodes 104 in the vicinity of the position indicated by the electrode information according to the generated electrode information. The sensor controller 13 selects the transmitting electrodes 102 and the receiving electrodes 104 in a similar manner to the operation of selecting the transmitting electrodes 102 and the receiving electrodes 104 by the second sensor controller 12 in the first embodiment. Next, at a time of signaling from the electrodes in the first mode or the second mode, the sensor controller 13 preferentially transmits the signal from the selected transmitting electrodes 102 and the selected receiving electrodes 104.

### Effects

As described above, in the second embodiment, the position detecting device 1B includes a sensor panel 10A having a receiving electrode 103 (first receiving electrode), a transmitting electrode 101 (first transmitting electrode) disposed so as to perpendicularly intersect the receiving electrode 103, a transmitting electrode 102 (second transmitting electrode) disposed so as to extend in a direction parallel with the transmitting electrode 101 such that one end of the transmitting electrode 102 is adjacent to one end of the transmitting electrode 101, and a receiving electrode 104 (second receiving electrode) disposed so as to perpendicularly intersect the transmitting electrode 102. The position detecting device 1B also includes a sensor controller 13 that detects a position on the sensor panel 10A based on signals detected by the transmitting electrode 101 and the receiving electrode 103, generates electrode information related to the detection, and makes a setting, according to the electrode information, for detection processing for position detection on the sensor panel 10A by the transmitting electrode 102 and the receiving electrode 104.

According to this configuration, in the position detecting device 1B, the transmitting electrodes 101 and 102 among the transmitting electrodes 101 and 102 and the receiving electrodes 103 and 104 on the sensor panel 10A are arranged as respective different electrodes on the sensor panel 10A. Capacitances accompanying the transmitting electrodes 101 and 102 are therefore suppressed. That is, in the position detecting device 1B, because the transmitting electrodes 101 and 102 are respective different electrodes, an accompanying capacitance per electrode is reduced as compared with a case where the transmitting electrode 101 and the transmitting electrode 102 having the same coordinate in the Y-axis direction are formed as one electrode. In addition, the position detecting device 1B performs position detection by one sensor controller 13. Hence, the position detecting device 1B can suppress a decrease in accuracy of position detection based on the capacitances accompanying the transmitting electrodes 101 and 102. The position detecting device 1B can therefore detect a position on the sensor panel 10A with high accuracy by one sensor controller 13.

In addition, in the second embodiment, a plurality of transmitting electrodes 101 and 102 and a plurality of receiving electrodes 103 and 104 are arranged on the sensor panel 10A, and the sensor controller 13 makes the setting according to the electrode information so as to transmit a signal for position detection from transmitting electrodes 102 (second transmitting electrodes) in a vicinity of the position indicated by the electrode information.

According to this configuration, the position detecting device 1B transmits the signal for position detection from the electrodes in the vicinity of the position indicated by the electrode information, and can therefore perform the position detection in the region A2 with higher accuracy.

In addition, in the second embodiment, the sensor controller 13 makes the setting according to the electrode information so as to increase a frequency of signal transmission for position detection from the transmitting electrode 102 (second transmitting electrode).

According to this configuration, the frequency of the position detection in the region A2 is increased based on the electrode information related to position detection in the region A1. Therefore, the position detection in the region A2 can be performed with higher accuracy.

### Third Embodiment

A third embodiment will now be described.

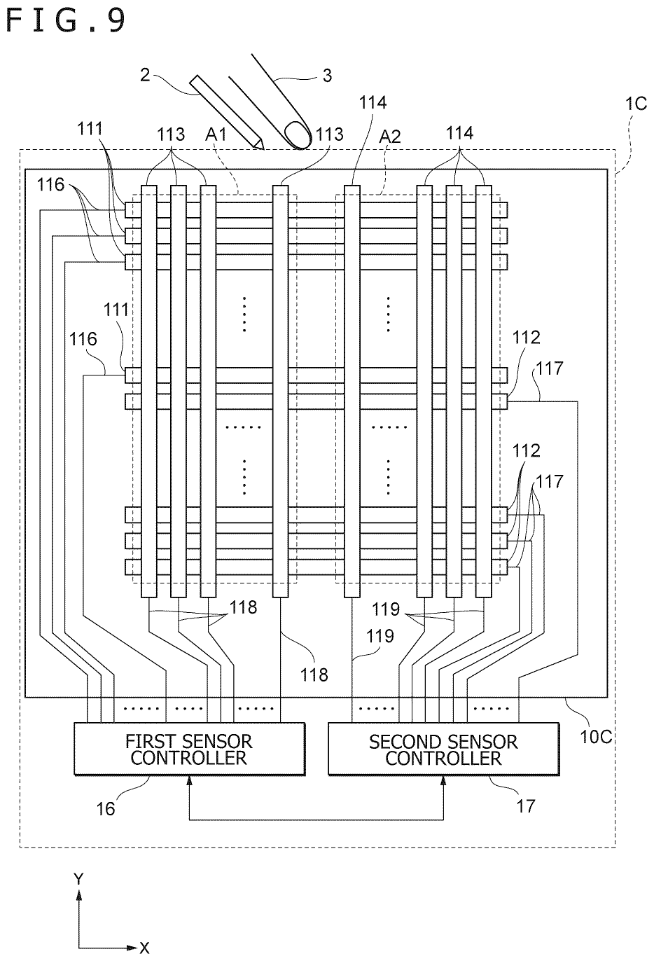

FIG. 9 is a diagram illustrating an example of a position detecting device 1C according to the third embodiment. A main part of the position detecting device 1C is configured by including, for example, a sensor panel 10C, a first sensor controller 16, and a second sensor controller 17.

The sensor panel 10C is configured such that the transmitting electrodes 101 and 102 are integrated with each other in the sensor panel 10A in the first embodiment and the second embodiment. The sensor panel 10C includes, for example, a plurality of X-line electrodes (hereinafter referred to as “receiving electrodes 113” or “receiving electrodes 114”) for detecting a position on an X-axis of a sensor coordinate system and a plurality of Y-line electrodes (hereinafter referred to as “transmitting electrodes 111” or “transmitting electrodes 112”) for detecting a position on a Y-axis of the sensor coordinate system. The transmitting electrodes 111 and 112 and the receiving electrodes 113 and 114 may be formed of a transparent conductive material including ITO, or may be formed by a wire mesh sensor.

The transmitting electrodes 111 are plurally arranged in an upper edge direction from the center of the sensor panel 10C so as to extend in the X-axis direction and so as to be parallel with each other. A transmitting electrode 111 nearest to the lower edge of the sensor panel 10C among the plurality of transmitting electrodes 111 is adjacent to a transmitting electrode 112 nearest to the upper edge of the sensor panel 10C. First ends of the transmitting electrodes 111 face in a right edge direction of the sensor panel 10C, and second ends thereof face in a left edge direction of the sensor panel 10C. Further, the second ends of the transmitting electrodes 111 are connected to the first sensor controller 16 via signal lines 116.

The transmitting electrodes 112 are plurally arranged in a lower edge direction from the center of the sensor panel 10C so as to extend in the X-axis direction and so as to be parallel with each other. The transmitting electrode 112 nearest to the upper edge of the sensor panel 10C among the plurality of transmitting electrodes 112 is adjacent to the transmitting electrode 111 nearest to the lower edge of the sensor panel 10C. First ends of the transmitting electrodes 112 face in the right edge direction of the sensor panel 10C, and second ends thereof face in the left edge direction of the sensor panel 10C. Further, the first ends of the transmitting electrodes 112 are connected to the second sensor controller 17 via signal lines 117.

The receiving electrodes 113 are plurally arranged in the left edge direction from the center of the sensor panel 10C so as to perpendicularly intersect the transmitting electrodes 111 and so as to be parallel with each other. First ends of the receiving electrodes 113 face in the upper edge direction of the sensor panel 10C, and second ends thereof face in the lower edge direction of the sensor panel 10C. In addition, the second ends of the receiving electrodes 113 are connected to the first sensor controller 16 via signal lines 118. In addition, together with the transmitting electrodes 111 and 112, the receiving electrodes 113 form a region A1 from the center to the left edge side of the sensor panel 10C, the region A1 including respective points of intersection of the transmitting electrodes 111 and the receiving electrodes 113 and respective points of intersection of the transmitting electrodes 111 and the receiving electrodes 113.

The receiving electrodes 114 are plurally arranged in the right edge direction from the center of the sensor panel 10C so as to perpendicularly intersect the transmitting electrodes 112 and so as to be parallel with each other. First ends of the receiving electrodes 114 face in the upper edge direction of the sensor panel 10C, and second ends thereof face in the lower edge direction of the sensor panel 10C. In addition, the second ends of the receiving electrodes 114 are connected to the second sensor controller 17 via signal lines 119. In addition, together with the transmitting electrodes 111 and 112, the receiving electrodes 114 form a region A2 from the center to the right edge side of the sensor panel 10C, the region A2 including respective points of intersection of the transmitting electrodes 111 and the receiving electrodes 114 and respective points of intersection of the transmitting electrodes 112 and the receiving electrodes 114.

First ends of each respective signal line 116 are connected to the second ends of the corresponding transmitting electrodes 111 among the plurality of transmitting electrodes 111, and the second ends of the signal lines 116 are connected to the first sensor controller 16 from the lower edge side of the sensor panel 10C. Incidentally, the second ends of the signal lines 116 are provided on the left edge side of second ends of the signal lines 118 on the sensor panel 10C.

First ends of each respective signal line 117 are connected to the first ends of the corresponding transmitting electrodes 112 among the plurality of transmitting electrodes 112, and the second ends of the signal lines 117 are connected to the second sensor controller 17 from the lower edge side of the sensor panel 10C. Incidentally, the second ends of the signal lines 117 are provided on the right edge side of second ends of the signal lines 119 on the sensor panel 10C.

First ends of each respective signal line 118 are connected to the second ends of the corresponding receiving electrodes 113 among the plurality of receiving electrodes 113, and the second ends of the signal lines 118 are connected to the first sensor controller 16 from the lower edge side of the sensor panel 10C. Incidentally, the second ends of the signal lines 118 are provided on the right edge side of the second ends of the signal lines 116 and on the left edge side of the second ends of the signal lines 119 on the sensor panel 10C. That is, the signal lines 118 are provided between the signal lines 116 and the signal lines 119 in the X-axis direction.

First ends of each respective signal line 119 are connected to the second ends of the corresponding receiving electrodes 114 among the plurality of receiving electrodes 114, and the second ends of the signal lines 119 are connected to the second sensor controller 17 from the lower edge side of the sensor panel 10C. Incidentally, the second ends of the signal lines 119 are provided on the right edge side of the second ends of the signal lines 118 and on the left edge side of the second ends of the signal lines 117 on the sensor panel 10C. That is, the signal lines 119 are provided between the signal lines 117 and the signal lines 118 in the X-axis direction.

The first sensor controller 16 and the second sensor controller 17 are functionally configured to be able to detect positions indicated by the stylus 2 and the finger 3 of the user on the sensor panel 10C and receive a data signal transmitted by the stylus 2 by reading and executing a program stored in a memory by a processor. Incidentally, the first sensor controller 16 detects an indicated position in the region A1 on the sensor panel 10C. In addition, the second sensor controller 17 detects an indicated position in the region A2 on the sensor panel 10C. The first sensor controller 16 and the second sensor controller 17 are configured to be able to communicate with each other. The first sensor controller 16 and the second sensor controller 17 share information regarding the detected positions by transmitting and receiving the information to and from each other, and make a setting for position detection processing based on the shared information regarding the positions. In addition, one of the first sensor controller 16 and the second sensor controller 17 converts the shared information regarding the positions in the regions A1 and A2 into information regarding the positions in a region including the regions A1 and A2 on the sensor panel 10C, and transmits the converted information to another device in the apparatus 20 mounted with the position detecting device 1C.

Similar to the first sensor controller 11 and the second sensor controller 12 in the first embodiment, the first sensor controller 16 and the second sensor controller 17 have an idle mode and an active mode with first to fourth modes, and control the position detecting device 1C while selecting, in order, these four kinds of modes in the active mode. Details of operation in each mode are as described in the first embodiment, and will therefore be omitted.

Next, details of a method of detecting a position on the sensor panel 10C in the first sensor controller 16 and the second sensor controller 17 will be described. The present example describes a case where the first sensor controller 16 detects a position in the region A1 on the sensor panel 10C and transmits the detected information to the second sensor controller 17. As for a case where the second sensor controller 17 detects a position in the region A2 on the sensor panel 10C and transmits the detected information to the first sensor controller 16, the same control is performed except that the electrodes, the signal lines, the region as a detection target, and the like are different, and therefore a description thereof will be omitted.

The first sensor controller 16 receives a signal detected by one of the transmitting electrodes 111 and the receiving electrodes 113. The reception of the signal is performed in the first mode and the third mode in a cycle in which the first sensor controller 16 selects the modes from the first mode to the fourth mode in order.

The first sensor controller 16 generates electrode information regarding a position on the sensor panel 10C on the basis of the signal received from the one of the transmitting electrodes 111 and the receiving electrodes 113. In the third embodiment, the electrode information includes, for example, detection information and position information. Further, the first sensor controller 16 transmits the generated electrode information to the second sensor controller 17.

On the basis of the electrode information transmitted from the first sensor controller 16, the second sensor controller 17 makes a setting for processing of detecting a position in the region A2 of the sensor panel 10C based on a signal detected from one of the transmitting electrodes 112 and the receiving electrodes 114. Further, the second sensor controller 17 converts information regarding the detected positions in the regions A1 and A2 into information regarding the positions in the region including the regions A1 and A2 on the sensor panel 10C. The second sensor controller 17 then transmits the converted information to another device in the apparatus 20 mounted with the position detecting device 1C.

Details of a concrete operation of the setting for the detection processing in the third embodiment will now be described. The second sensor controller 17 makes the setting for the detection processing so as to increase a frequency of signal transmission for position detection from the transmitting electrodes 112 and the receiving electrodes 114 according to the electrode information. Specifically, the second sensor controller 17 increases the frequency of transmitting the signal for position detection from the transmitting electrodes 112 and the receiving electrodes 114 in the second mode by shortening a cycle of selecting the modes from the first mode to the fourth mode. In addition, shortening the cycle of selecting the modes from the first mode to the fourth mode also increases a frequency of detection of a position indication by the finger 3 in the first mode.

In addition, the second sensor controller 17 makes a setting, according to the electrode information generated by the first sensor controller 16, so as to transmit the signal for position detection from transmitting electrodes 112 and receiving electrodes 114 in the vicinity of the position indicated by the electrode information. The second sensor controller 17 selects the transmitting electrodes 112 and the receiving electrodes 114 in a similar manner to the operation of selecting the transmitting electrodes 102 and the receiving electrodes 103 by the second sensor controller 12 in the first embodiment. Incidentally, in the third embodiment, there is a case where, for example, only either of the transmitting electrodes 111 and the receiving electrodes 113 detect signals on the side of the first sensor controller 16. In that case, the second sensor controller 17 selects the transmitting electrodes 112 and the receiving electrodes 114 on the basis of the electrode information including the detection information and the position information related to only the signals of either of the transmitting electrodes 111 and the receiving electrodes 113.

For example, in a case where a position from the center to the upper edge side of the sensor panel 10C in the region A2 is indicated by the stylus 2 or the finger 3, the first sensor controller 16 receives only detected signals by the transmitting electrodes 111 which signals indicate that the position is indicated. In addition, the second sensor controller 17 receives only signals detected by the receiving electrodes 113 which signals indicate that the position is indicated. In this case, the first sensor controller 16 generates the electrode information, and transmits the generated electrode information to the second sensor controller 17. Next, the second sensor controller 17 selects a few transmitting electrodes 112 in increasing order of distance from the upper edge side of the sensor panel 10C among the transmitting electrodes 112 on the basis of the electrode information received from the first sensor controller 16. Next, at a time of signaling from the electrodes in the first mode or the second mode, the second sensor controller 17 preferentially transmits the signal from the selected transmitting electrodes 112 and the receiving electrodes 114.

Further, in the third embodiment, in the case where only either of the transmitting electrodes 111 and the receiving electrodes 113 detect signals, the first sensor controller 16 generates electrode identifying information, coordinate information, movement information, prediction information, and the like so as to include only information related to a direction of the X-axis direction and the Y-axis direction which corresponds to the electrodes detecting the signals, and generates the electrode information so as to include the generated information.

In addition, in the third embodiment, in a case where the first sensor controller 16 receives the signals from the transmitting electrodes 111 and the receiving electrodes 113 as differential signals, the first sensor controller 16 may convert the received signals into actual voltage values by performing an integral operation on the received signals and generate the electrode information on the basis of the converted voltage values, as in the first embodiment. Incidentally, in the case where only either of the transmitting electrodes 111 and the receiving electrodes 113 detect signals, the first sensor controller 16 performs the integral operation only in the direction of the X-axis direction and the Y-axis direction which corresponds to the electrodes detecting the signals, and generates the electrode information on the basis of a result of the integral operation.

In addition, in the third embodiment, in generating the electrode information, in order to reduce an amount of data communication by transmission and reception of the electrode information, the first sensor controller 16 may generate the electrode information after thinning out unnecessary signals among the signals detected by the transmitting electrodes 111 and the receiving electrodes 113 as in the first embodiment. In the case where only either of the transmitting electrodes 111 and the receiving electrodes 113 detect signals, the first sensor controller 16 performs the thinning out only in the direction of the X-axis direction and the Y-axis direction which corresponds to the electrodes detecting the signals, and generates the electrode information based on a result of the thinning out.

### Effects

As described above, in the third embodiment, the position detecting device 1C includes a sensor panel 10C having a transmitting electrode 111 (first transmitting electrode), a receiving electrode 113 (first receiving electrode) disposed so as to perpendicularly intersect the transmitting electrode 111, a receiving electrode 114 (second receiving electrode) disposed in parallel with the receiving electrode 113, and a transmitting electrode 112 (third transmitting electrode) perpendicularly intersecting the receiving electrode 113 and the receiving electrode 114 and arranged in parallel with the transmitting electrode 111. The position detecting device 1C further includes a first sensor controller 16 that detects a position on the sensor panel 10C based on signals detected by the transmitting electrode 111 and the receiving electrode 113, generates electrode information related to the detection, and transmits the electrode information. The position detecting device 1C further includes a second sensor controller 17 that, based on the electrode information transmitted from the first sensor controller 16, makes a setting for processing of detecting a position on the sensor panel 10C based on signals detected from the transmitting electrode 112 and the receiving electrode 114.

According to this configuration, by the two sensor controllers, that is, the first sensor controller 16 and the second sensor controller 12, the position detecting device 1C detects a position on the sensor panel 10C based on the signals detected by the transmitting electrodes 111 and 112 and the receiving electrodes 113 and 114 on the sensor panel 10C. Hence, the position detecting device 1C can detect a position on the sensor panel 10C even in a case where the sensor panel 10C has many electrodes.

In addition, in the third embodiment, the position detecting device 1C may generate the electrode information so as to include detection information as in the first embodiment, and position information including coordinate information, movement information, prediction information, and the like. Further, in generating the coordinate information, the position detecting device 1C may calculate a gravity center on the basis of a zeroth-order moment value and a first-order moment value as in the first embodiment.

According to this configuration, the position detecting device 1C can detect a position on the sensor panel 10C with high accuracy and low power consumption also in a case where the electrodes are not divided in the middle on the sensor panel 10C.

### Fourth Embodiment

A fourth embodiment will now be described.

### Configuration

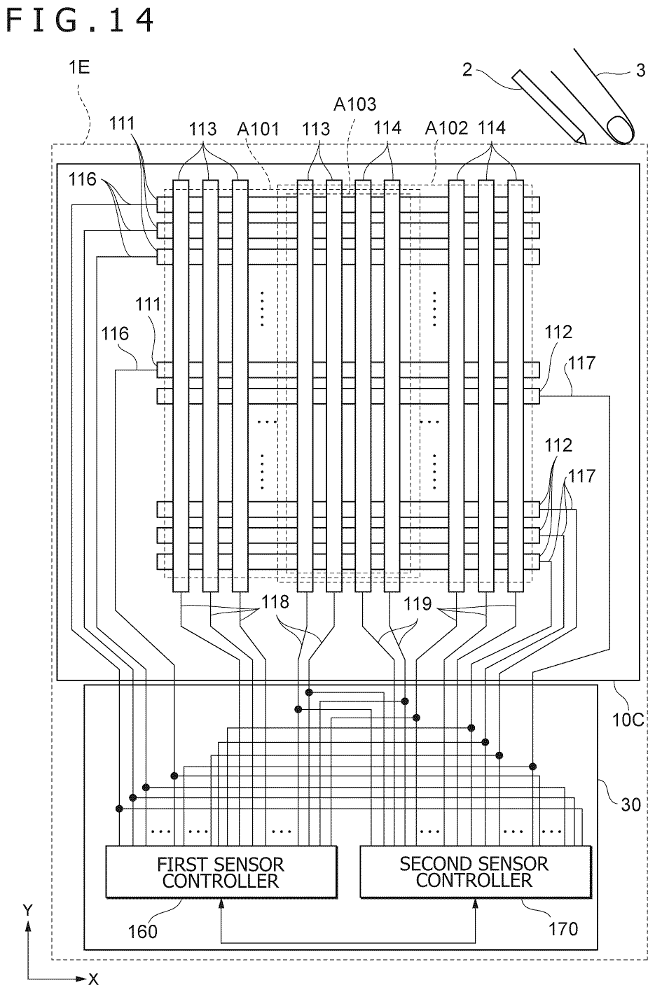

FIG. 14 is a diagram illustrating an example of a position detecting device 1E according to the fourth embodiment. A main part of the position detecting device 1E is configured by including, for example, a sensor panel 10C and a circuit board 30 provided with a first sensor controller 160 and a second sensor controller 170. The sensor panel 10C is as described in the third embodiment, and therefore a description thereof will be omitted. The following features will be described, including connection relation between the transmitting electrodes 111 and 112, the receiving electrodes 113 and 114, the signal lines 116 to 119, the first sensor controller 160, and the second sensor controller 170 as well as regions A101 to A103 formed by the transmitting electrodes 111 and 112 and the receiving electrodes 113 and 114.

Second ends of the transmitting electrodes 111 are connected to the first sensor controller 160 and the second sensor controller 170 on the circuit board 30 via the signal lines 116. In addition, second ends of the transmitting electrodes 112 are connected to the first sensor controller 160 and the second sensor controller 170 on the circuit board 30 via the signal lines 117.

Together with the transmitting electrodes 111 and 112, the receiving electrodes 113 form a region A101 from the center to the left edge side of the sensor panel 10C, the region A101 including respective points of intersection of the transmitting electrodes 111 and the receiving electrodes 113 and respective points of intersection of the transmitting electrodes 111 and the receiving electrodes 113.

Together with the transmitting electrodes 111 and 112, the receiving electrodes 114 form a region A102 from the center to the right edge side of the sensor panel 10C, the region A102 including respective points of intersection of the transmitting electrodes 111 and the receiving electrodes 114 and respective points of intersection of the transmitting electrodes 112 and the receiving electrodes 114.

Incidentally, of the receiving electrodes 113 and 114, a few receiving electrodes 113 to the left edge side from a receiving electrode 113 located most to the right edge side among the receiving electrodes 113 and a few receiving electrodes 114 to the right edge side from a receiving electrode 114 located most to the left edge side among the receiving electrodes 114 form a region A103 that overlaps the regions A101 and A102 as viewed in plan.

Second ends of the receiving electrodes 113 are connected to the first sensor controller 160 on the circuit board 30 via the signal lines 118. In addition, the receiving electrodes 113 forming the region A103 among the receiving electrodes 113 are connected to the second sensor controller 170 as well as to the first sensor controller 160 via the signal lines 118.

Second ends of the receiving electrodes 114 are connected to the first sensor controller 160 on the circuit board 30 via the signal lines 119. In addition, the receiving electrodes 114 forming the region A103 among the receiving electrodes 114 are connected to the second sensor controller 170 as well as to the first sensor controller 160 via the signal lines 119.

First ends of each respective signal line 116 are connected to the first ends of the corresponding transmitting electrodes 112 among the plurality of transmitting electrodes 111, and second ends of the signal lines 116 are connected to the first sensor controller 160 and the second sensor controller 170 on the circuit board 30 from the lower edge side of the sensor panel 10C.

First ends of each respective signal line 117 are connected to the first ends of the corresponding transmitting electrodes 112 among the plurality of transmitting electrodes 112, and second ends of the signal lines 117 are connected to the first sensor controller 160 and the second sensor controller 170 on the circuit board 30 from the lower edge side of the sensor panel 10C.

First ends of each respective signal line 118 are connected to the second ends of the corresponding receiving electrodes 113 among the plurality of receiving electrodes 113, and second ends of the signal lines 118 are connected to the first sensor controller 160 on the circuit board 30 from the lower edge side of the sensor panel 10C. Additionally, the second ends of signal lines 118 that are connected to the receiving electrodes 113 forming the region A103are connected not only to the first sensor controller 160, but also to the second sensor controller 170.

First ends of each respective signal line 119 are connected to the second ends of the corresponding receiving electrodes 114 among the plurality of receiving electrodes 114, and second ends of the signal lines 119 are connected to the second sensor controller 170 on the circuit board 30 from the lower edge side of the sensor panel 10C. Additionally, the second ends of signal lines 119 connected to the receiving electrodes 114 forming the region A103 are connected not only to the second sensor controller 170, but also to the first sensor controller 160.

The circuit board 30 is provided to the lower edge side of the sensor panel 10C, and includes branching parts of the signal lines 116 to 119. The branching parts branch to the first sensor controller 160 and the second sensor controller 170 as well as the first sensor controller 160 and the second sensor controller 170. The circuit board 30 may be connected to the sensor panel 10C by a flexible board or the like provided with intermediate parts of the signal lines 116 to 119. It is to be noted that, while, in the present embodiment, the branching parts of the signal lines 116 to 119 as well as the first sensor controllers 160 and 170 are provided on the circuit board 30, other embodiments are not limited as such. The branching parts of the signal lines 116 to 119, as well as the sensor controllers 160 and 170, may be provided independently in the position detecting device 1E.

The first sensor controller 160 and the second sensor controller 170 are provided on the circuit board 30, and are functionally configured to be able to detect positions indicated by the stylus 2 and the finger 3 of the user on the sensor panel 10C and receive a data signal transmitted by the stylus 2 by reading and executing a program stored in a memory by a processor. The first sensor controller 160 detects an indicated position in the regions A101 and 103 on the sensor panel 10C. In addition, the second sensor controller 170 detects an indicated position in the regions A102 and 103 on the sensor panel 10C. The first sensor controller 160 and the second sensor controller 170 are configured to be able to communicate with each other. The first sensor controller 160 and the second sensor controller 170 share information regarding the detected positions by transmitting and receiving the information to and from each other, and make a setting for position detection processing based on the shared information regarding the positions. In addition, one of the first sensor controller 160 and the second sensor controller 170 converts the shared information regarding the positions in the regions A101 to A103 into information regarding the positions in a region including the regions A101 to 103 on the sensor panel 10C, and transmits the converted information to another device in the apparatus 20 mounted with the position detecting device 1C.

Similar to the first sensor controller 11 and the second sensor controller 12 in the first embodiment, the first sensor controller 160 and the second sensor controller 170 have an idle mode and an active mode with first to fourth modes, and control the position detecting device 1C while selecting, in order, these four kinds of modes in the active mode. Additionally, in the fourth embodiment, the first sensor controller 160 and the second sensor controller 170 perform position detection operations alternately, with respect to one another, while the first sensor controller's 160 selection of the first to fourth modes in order and the second sensor controller's 170 subsequent selection of the first to fourth modes in order by the second sensor controller 170 are set as one set. Alternatively, in each of the first to fourth modes, the first sensor controller 160 and the second sensor controller 170 alternately perform operations in each mode. Details of the operation in each mode are as described in the first embodiment, and will therefore be omitted.

Next, details of a method of detecting a position on the sensor panel 10C by the first sensor controller 160 and the second sensor controller 170 will be described. The first sensor controller 160 receives a signal detected by one of the transmitting electrodes 111 and 112 and the receiving electrodes 113 and 114 in the regions A101 and A103. In addition, the reception of the signal is performed in the first mode and the third mode in a cycle in which the first sensor controller 160 selects the modes from the first mode to the fourth mode in order.

The first sensor controller 160 generates electrode information regarding a position on the sensor panel 10C based on the signal received from the one of the transmitting electrodes 111 and in 112 and the receiving electrodes 113 and 114 in the regions A101 and A103. In the fourth embodiment, the electrode information includes, for example, detection information and position information. Further, the first sensor controller 160 transmits the generated electrode information to the second sensor controller 170.

The second sensor controller 170 receives the electrode information from the first sensor controller 160, converts information regarding the position in the regions A101 and A103 into information regarding the position in the region including the regions A101 and A102 on the sensor panel 10C, and transmits the converted information to another device in the apparatus 20 mounted with the position detecting device 1C.

The second sensor controller 170 also receives a signal detected by one of the transmitting electrodes 111 and 112 and the receiving electrodes 113 and 114 in the regions A102 and A103. In addition, the reception of the signal is performed in the first mode and the third mode in a cycle in which the second sensor controller 170 selects the modes from the first mode to the fourth mode in order. The second sensor controller 170 extracts information regarding a position in the regions A102 and A103 from the received signal, and converts the extracted information into information regarding the position in the region including the regions A101 and A102 on the sensor panel 10C.

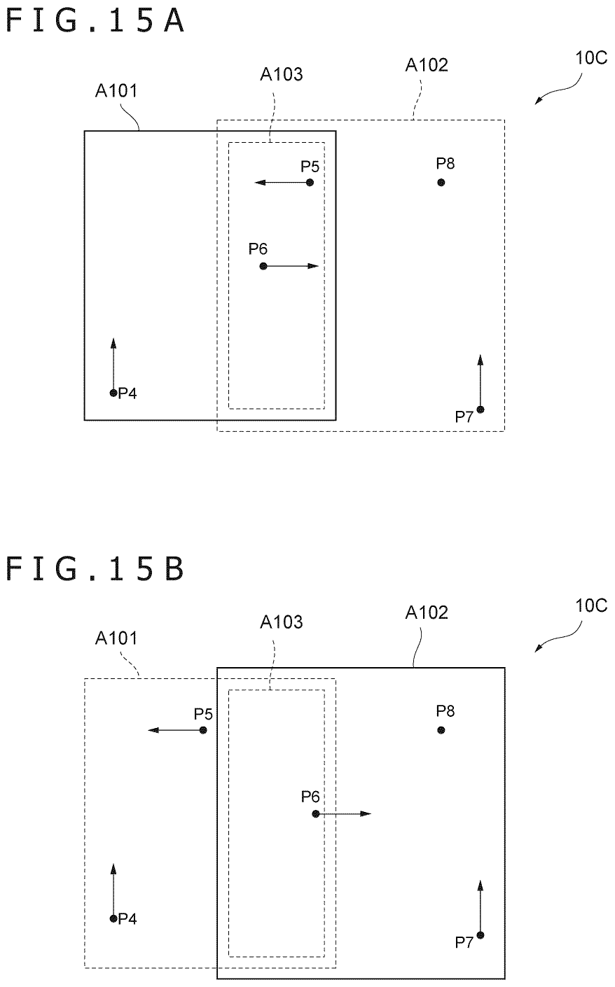

Referring to FIGS. 15A and 15B, a concrete example of operation of the first sensor controller 160 and the second sensor controller 170 in the fourth embodiment will be described. FIG. 15A is a diagram designed to assist in explaining position detection in a case where the first sensor controller 160 detects a position indication. FIG. 15B is a diagram designed to assist in explaining position detection in a case where the second sensor controller 170 detects a position indication.

In a state illustrated in FIG. 15A, the first sensor controller 160 detects position indications in the regions A101 and A103. The first sensor controller 160 detects position indications of a point P5 that moves in a leftward direction and a point P6 that moves in a rightward direction in the region A103. In addition, the first sensor controller 160 detects a position indication of a point P4 that moves in an upward direction in the region A101. The first sensor controller 160 generates electrode information including position information and detection information from the detected position indications, and transmits the electrode information to the second sensor controller 170. The second sensor controller 170 converts information regarding the position indications, which is included in the electrode information from the first sensor controller 160, and transmits the converted information to another device in the apparatus 20 mounted with the position detecting device 1C. Incidentally, during a period where the first sensor controller 160 is detecting the position indications, the second sensor controller 170 stops the detection of position indications in the regions A102 and A103.

After the first sensor controller 160 detects the position indications in the state illustrated in FIG. 15A, the first sensor controller 160 stops the detection of position indications in the regions A101 and A103 in a state illustrated in FIG. 15B. In addition, the second sensor controller 170 detects a position indication of the point P6 that moves in the rightward direction in the region A103. Also, the second sensor controller 170 detects a position indication of a point P7 that moves in the upward direction and a position indication of a point P8 that continues to stay at a substantially same position in the region A102. The second sensor controller 170 converts information regarding the detected position indications, and transmits the converted information to another device in the apparatus 20 mounted with the position detecting device 1C. During a period where the second sensor controller 170 is detecting the position indications, the first sensor controller 160 stops the detection of position indications in the regions A101 and A103.

In the fourth embodiment, as in the third embodiment, at a time of receiving the electrode information transmitted from the first sensor controller 160, the second sensor controller 170 may make a setting for position detection processing in the region A2 of the sensor panel 10C based on the signal detected from one of the transmitting electrodes 111 and 112 and the receiving electrodes 113 and 114.

Specifically, the second sensor controller 170 may make a setting, according to the electrode information generated by the first sensor controller 160, so as to transmit a signal for position detection from transmitting electrodes 111 and 112 and receiving electrodes 113 and 114 in the vicinity of the positions indicated by the electrode information. More preferably, in a case where the electrode information indicates that a position indication is performed at one of the transmitting electrodes 111 and 112 and the receiving electrodes 113 and 114 in the region A103, the second sensor controller 170 may make a setting so as to transmit the signal for position detection from transmitting electrodes 111 and 112 and receiving electrodes 113 and 114 in the vicinity of the position indicated by the electrode information.

### Effects

As described above, in the fourth embodiment, the position detecting device 1E includes a sensor panel 10C formed by arranging a plurality of electrodes for position detection in a planar shape such that the plurality of electrodes intersect each other, the sensor panel 10C having a region A101 (first region) that is one of regions in which the plurality of electrodes intersect each other, a region A102 (second region) that is one of the regions in which the plurality of electrodes intersect each other, the region A102 (second region) partly overlapping the region A101 as viewed in plan and being different from the region A101, and a region A103 (overlap region) that is a region in which the region A101 and the region A102 overlap each other as viewed in plan. In addition, the position detecting device 1E includes a first sensor controller 160 that detects a position in the region A101 and detects a position in the region A103 in a first period in detecting the position in the region A101, and a second sensor controller 170 that detects a position in the region A102 and detects a position in the region A103 in a second period continuous with the first period in detecting the position in the region A102.

According to this configuration, by the first sensor controller 160 and the second sensor controller 170, the position detecting device 1E detects a position indication in the region A103 that overlaps the regions A101 and 102 as viewed in plan. Hence, at a time of detecting a position indication with a region on the sensor panel 10C divided into a plurality of regions, the position detecting device 1E can reduce overlap and disappearance of an indicated position that accompany a shift in timing of performing the position indication and overlap thereof.

In addition, in the fourth embodiment, the first sensor controller 160 generates electrode information related to the detection of the position in the region A103, and transmits the electrode information to the second sensor controller 170. The second sensor controller 170 makes a setting for processing of detecting the position in the region A103 on the basis of the electrode information transmitted from the first sensor controller 160.

According to this configuration, the first sensor controller 160 transmits the electrode information related to one detection to the second sensor controller 170, so that at a time of detecting a position indication with higher accuracy with a region on the sensor panel 10C divided into a plurality of regions, the position detecting device 1E can reduce overlap and disappearance of an indicated position that accompany a shift in timing of performing the position indication and overlap thereof.

In addition, in the fourth embodiment, the electrode information includes coordinate information indicating the position in the region A103The second sensor controller 170 detects the position in a region in a vicinity of the position indicated by the coordinate information in the second period.

According to this configuration, the electrode information includes the coordinate information, so that, at a time of detecting a position indication with even higher accuracy with a region on the sensor panel 10C divided into a plurality of regions, the position detecting device 1E can reduce overlap and disappearance of an indicated position that accompany a shift in timing of performing the position indication and overlap thereof.

### Modifications

It is to be noted that the present disclosure is not limited to the foregoing embodiments. That is, the foregoing embodiments modified in design by those skilled in the art as appropriate are also included in the scope of the present disclosure as long as the modified embodiments have features of the present disclosure. In addition, elements included in the foregoing embodiments and modifications to be described later can be combined with one another where technically possible. Combinations of these elements are also included in the scope of the present disclosure as long as the combinations include features of the present invention.

For example, in the first embodiment, the electrode information is information regarding a position in the region A1 detected by the transmitting electrodes 101 and the receiving electrodes 103, information regarding a position in the region A2 detected by the transmitting electrodes 102 and the receiving electrodes 104, and the like. However, the electrode information is not limited to these examples. The electrode information may be, for example, information indicating to which of the regions A11, A12, A21, and A22 the position of the stylus 2 or the finger 3 corresponds.

In this configuration, when the stylus 2 or the finger 3 is detected by a transmitting electrode 101 and a receiving electrode 103, the first sensor controller 11 determines in which of the regions A11 and A12 the detecting transmitting electrodes 101 are disposed. The first sensor controller 11 generates, as the electrode information, information regarding the detection of the stylus 2 or the finger 3 at each of the points of intersection of the transmitting electrodes 101 and the receiving electrodes 103 in the determined region, and transmits the generated electrode information to the second sensor controller 12. It is to be noted that, in this configuration, the electrode information is the value of a potential at each of the points of intersection of the transmitting electrodes 101 and the receiving electrodes 103, but is not limited to this. The electrode information may be any information as long as the electrode information is a parameter related to changes in capacitance between the transmitting electrodes 101 and the receiving electrodes 103. The electrode information may be a rate of a change in capacitance, the value of electric resistance, the value of current, or the like. In addition, instead of generating the electrode information so as to include the zeroth-order moment and the first-order moment, the first sensor controller 11 may generate, as the electrode information, information regarding the detection of the stylus 2 or the finger 3 at each of the points of intersection of the transmitting electrodes 101 and the receiving electrodes 103 in the regions A11 and A12. Operation of the second sensor controller 12 is similar to that of the first sensor controller 11 except that the region for which detection and determination are performed is different. A description thereof will therefore be omitted.

According to this configuration, when the stylus 2 or the finger 3 is detected, the position detecting device 1A generates information regarding a region as the divided region A11, A12, A21, or A22 as the electrode information rather than information regarding the whole of the region A1 or A2. Hence, the amount of information included in the electrode information is reduced, so that the position detecting device 1A suppresses the amount of communication of the electrode information, thereby allowing a reduction in power consumption.

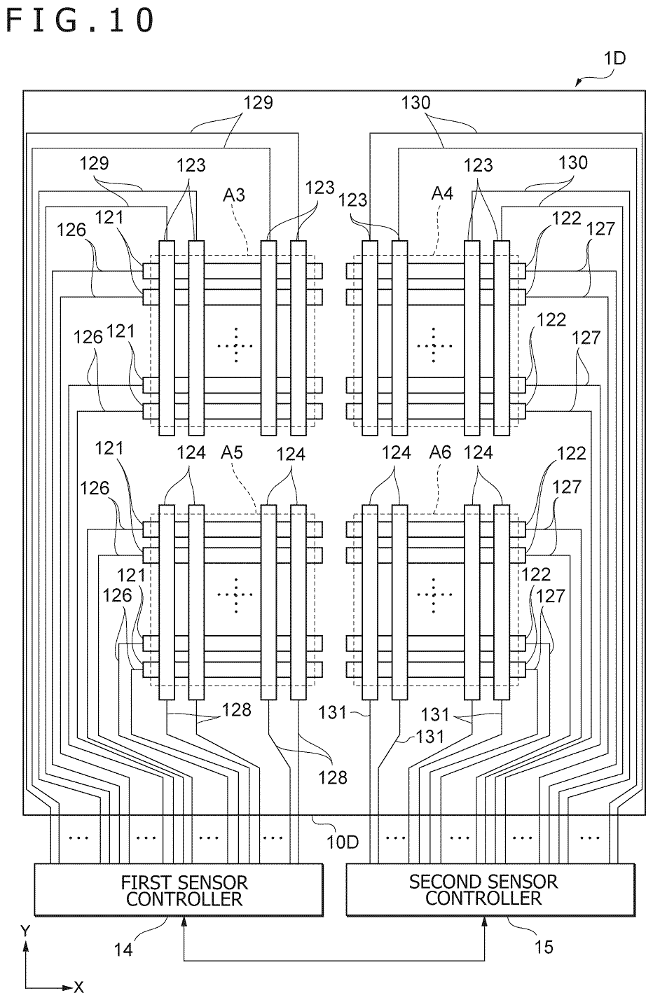

In addition, for example, in the first embodiment and the second embodiment, the receiving electrodes 103 are arranged on the sensor panel 10A from the upper edge side to the lower edge side so as to straddle the center. However, other embodiments are not limited as such. The receiving electrodes 103 may be arranged so as to be divided into the upper edge side and the lower edge side with the center as a boundary. Here, another example of the arrangement of the electrodes will be described with reference to FIG. 10. FIG. 10 is a diagram illustrating a fourth example of a position detecting device 1D.

The position detecting device 1D detects positions indicated by the stylus 2 and the finger 3 of the user, and performs various types of information processing according to a result of the detection. A main part of the position detecting device 1D is configured by including, for example, a sensor panel 10D, a first sensor controller 14, and a second sensor controller 15.

The sensor panel 10D is configured such that the receiving electrodes 103, as shown in the sensor panel 10A in the first embodiment and the second embodiment, are arranged in a divided manner. The sensor panel 10D includes, for example, a plurality of X-line electrodes (hereinafter referred to as “receiving electrodes 123” or “receiving electrodes 124”) for detecting a position on an X-axis of a sensor coordinate system and a plurality of Y-line electrodes (hereinafter referred to as “transmitting electrodes 121” or “transmitting electrodes 122”) for detecting a position on a Y-axis of the sensor coordinate system. The transmitting electrodes 121 and 122 and the receiving electrodes 123 and 124 may be formed of a transparent conductive material including ITO, or may be formed by a wire mesh sensor. Incidentally, the transmitting electrodes 121 and 122 are similar to those of the first embodiment, and therefore a description thereof will be omitted.

The receiving electrodes 123 are plurally arranged on the sensor panel 10D so as to extend in the Y-axis direction and so as to be parallel with each other. First ends of the receiving electrodes 123 face in the lower edge direction of the sensor panel 10D, and second ends thereof face in the upper edge direction of the sensor panel 10D. Further, the first ends of the receiving electrodes 123 are adjacent to and facing the first ends of the corresponding receiving electrodes 124. In addition, the second ends of the receiving electrodes 123 from the center to the left edge side in the sensor panel 10D are connected to the first sensor controller 14 via signal lines 129. In addition, the second ends of the receiving electrodes 123 from the center to the right edge side in the sensor panel 10D are connected to the second sensor controller 15 via signal lines 130.

Together with a plurality of transmitting electrodes 121 from the center to the upper edge side in the sensor panel 10D, a plurality of receiving electrodes 123 from the center to the left edge side in the sensor panel 10D form a region A3 including respective points of intersection of the receiving electrodes 123 and the transmitting electrodes 121 on the sensor panel 10D. In addition, together with a plurality of transmitting electrodes 122 from the center to the upper edge side in the sensor panel 10D, a plurality of receiving electrodes 123 from the center to the right edge side in the sensor panel 10D form a region A4 including respective points of intersection of the receiving electrodes 123 and the transmitting electrodes 122 on the sensor panel 10D.

The receiving electrodes 124 are plurally arranged on the sensor panel 10D so as to extend in the Y-axis direction and so as to be parallel with each other. First ends of the receiving electrodes 124 face in the upper edge direction of the sensor panel 10D, and second ends thereof face in the lower edge direction of the sensor panel 10D. Further, the first ends of the receiving electrodes 124 are adjacent to and facing the first ends of the corresponding receiving electrodes 123. In addition, the second ends of the receiving electrodes 124 from the center to the left edge side in the sensor panel 10D are connected to the first sensor controller 14 via signal lines 128. The second ends of the receiving electrodes 124 from the center to the right edge side in the sensor panel 10D are connected to the second sensor controller 15 via signal lines 131.

Together with a plurality of transmitting electrodes 121 from the center to the lower edge side in the sensor panel 10D, a plurality of receiving electrodes 124 from the center to the left edge side in the sensor panel 10D form a region A5 including respective points of intersection of the receiving electrodes 124 and the transmitting electrodes 121 on the sensor panel 10D. In addition, together with a plurality of transmitting electrodes 122 from the center to the lower edge side in the sensor panel 10D, a plurality of receiving electrodes 124 from the center to the right edge side in the sensor panel 10D form a region A6 including respective points of intersection of the receiving electrodes 124 and the transmitting electrodes 122 on the sensor panel 10D.

Signal lines 126 are plurally provided on the sensor panel 10D, and transmit signals between the transmitting electrodes 121 and the first sensor controller 14. The signal lines 126 are respectively associated with the transmitting electrodes 121. First ends of the signal lines 126 are connected to second ends of the corresponding transmitting electrodes 121, and second ends thereof are connected to the first sensor controller 14 from the lower edge side of the sensor panel 10D. The second ends of the signal lines 126 are provided on the right edge side of second ends of the signal line 129 and on the left edge side of second ends of the signal lines 128 on the sensor panel 10D. That is, the signal lines 126 are provided between the signal lines 129 and the signal lines 128 in the X-axis direction.

Signal lines 127 are plurally provided on the sensor panel 10D, and transmit signals between the transmitting electrodes 122 and the second sensor controller 15. The signal lines 127 are respectively associated with the transmitting electrodes 122. First ends of the signal lines 127 are connected to second ends of the corresponding transmitting electrodes 122, and second ends thereof are connected to the second sensor controller 15 from the lower edge side of the sensor panel 10D. The second ends of the signal lines 127 are provided on the right edge side of second ends of the signal lines 131 and on the left edge side of second ends of the signal lines 130 on the sensor panel 10D. That is, the signal lines 127 are provided between the signal lines 130 and the signal lines 131 in the X-axis direction.

The signal lines 128 are plurally provided on the sensor panel 10D, and transmit signals between the receiving electrodes 124 from the center to the left edge side in the sensor panel 10D and the first sensor controller 14. The signal lines 128 are respectively associated with the receiving electrodes 124 from the center to the left edge side in the sensor panel 10D. First ends of the signal lines 128 are connected to the second ends of the corresponding receiving electrodes 124, and second ends thereof are connected to the first sensor controller 14 from the lower edge side of the sensor panel 10D. The second ends of the signal lines 128 are provided on the right edge side of the second ends of the signal lines 128 and on the left edge side of the second ends of the signal lines 131 on the sensor panel 10D. That is, the signal lines 128 are provided between the signal lines 126 and the signal lines 131 in the X-axis direction.

The signal lines 129 are plurally provided on the sensor panel 10D, and transmit signals between the receiving electrodes 123 from the center to the left edge side in the sensor panel 10D and the first sensor controller 14. The signal lines 129 are respectively associated with the receiving electrodes 123 from the center to the left edge side in the sensor panel 10D. First ends of the signal lines 129 are connected to the second ends of the corresponding receiving electrodes 123, and second ends thereof are connected to the first sensor controller 14 from the lower edge side of the sensor panel 10D. The second ends of the signal lines 129 are provided on the left edge side of the second ends of the signal lines 126 on the sensor panel 10D.

The signal lines 130 are plurally provided on the sensor panel 10D, and transmit signals between the receiving electrodes 123 from the center to the right edge side in the sensor panel 10D and the second sensor controller 15. The signal lines 130 are respectively associated with the receiving electrodes 123 from the center to the right edge side in the sensor panel 10D. First ends of the signal lines 130 are connected to the second ends of the corresponding receiving electrodes 123, and second ends thereof are connected to the second sensor controller 15 from the lower edge side of the sensor panel 10D. The second ends of the signal lines 130 are provided on the right edge side of the second ends of the signal lines 127 on the sensor panel 10D.

The signal lines 131 are plurally provided on the sensor panel 10D, and transmit signals between the receiving electrodes 124 from the center to the right edge side in the sensor panel 10D and the second sensor controller 15. The signal lines 131 are respectively associated with the receiving electrodes 124 from the center to the right edge side in the sensor panel 10D. First ends of the signal lines 131 are connected to the second ends of the corresponding receiving electrodes 124, and second ends thereof are connected to the second sensor controller 15 from the lower edge side of the sensor panel 10D. The second ends of the signal lines 131 are provided on the right edge side of the second ends of the signal lines 128 and on the left edge side of the second ends of the signal lines 127 on the sensor panel 10D. That is, the signal lines 131 are provided between the signal lines 128 and the signal lines 127 in the X-axis direction.

The first sensor controller 14 and the second sensor controller 15 are functionally configured to be able to detect positions indicated by the stylus 2 and the finger 3 of the user on the sensor panel 10D and receive a data signal transmitted by the stylus 2 by reading and executing a program stored in a memory by a processor. The first sensor controller 14 detects an indicated position in the regions A3 and A5 on the sensor panel 10D. In addition, the second sensor controller 15 detects an indicated position in the regions A4 and A6 on the sensor panel 10D. The first sensor controller 14 and the second sensor controller 15 are configured to be able to communicate with each other. The first sensor controller 14 and the second sensor controller 15 share information regarding the detected positions by transmitting and receiving the information to and from each other, and make a setting for position detection processing on the basis of the shared information regarding the positions. One of the first sensor controller 14 and the second sensor controller 15 converts the shared information regarding the positions in the regions A3 to A6 into information regarding the positions in a region including the regions A3 to A6 on the sensor panel 10D, and transmits the converted information to another device in the apparatus 20 mounted with the position detecting device 1D.

Similar to the first sensor controller 11 and the second sensor controller 12 in the first embodiment, the first sensor controller 14 and the second sensor controller 15 have an idle mode and an active mode with first to fourth modes, and control the position detecting device 1D while selecting, in order, these four kinds of modes in the active mode. Details of operation of the first sensor controller 14 and the second sensor controller 15 in each mode are as described in the first embodiment, and will therefore be omitted. In addition, details of a method of detecting a position on the sensor panel 10D in the first sensor controller 16 and the second sensor controller 17 are also similar to those of the first embodiment except that the number of signal lines is increased by providing the receiving electrodes 123 and 124 in place of the receiving electrodes 103. A description thereof will therefore be omitted.

According to this configuration, the receiving electrodes 123 and 124 are each provided separately on the sensor panel 10D, so that the position detecting device 1D can detect a position on the sensor panel 10D with high accuracy.

In addition, in the foregoing embodiment, the first sensor controller 14 may generate electrode information for each of the regions A3 and A5, and transmit the generated electrode information to the second sensor controller 15. In addition, the second sensor controller 15 may generate electrode information for each of the regions A4 and A6 and transmit the generated electrode information to the first sensor controller 14. Further, one of the first sensor controller 14 and the second sensor controller 15 may detect the positions in the region including the regions A3 to A6 on the sensor panel 10D based on the received electrode information for the two regions and information regarding the detected position in the two regions.

According to this configuration, the position detecting device 1D generates the electrode information for each of the regions A3 to A6, and detects the positions in the regions A3 to A6 on the sensor panel 10D based on the generated electrode information. Hence, the position detecting device 1D can detect the positions on the sensor panel 10D with even higher accuracy.

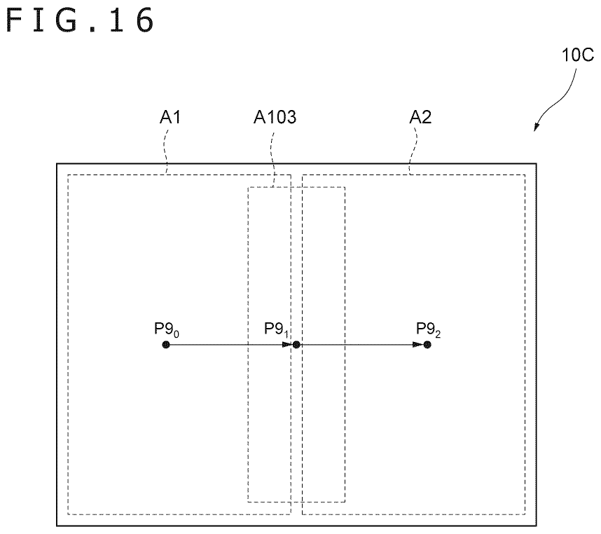

In addition, in the fourth embodiment, the regions A101 and A102 of the sensor panel 10C overlap each other as viewed in plan, and the whole of the overlap region A103 is included in the regions A101 and A102. However, other embodiments are not limited as such. In the fourth embodiment, the region A103 of the sensor panel 10C may be provided so as to straddle the vicinities of the boundary between the regions A1 and A2 as in FIG. 9. This configuration will now be described with reference to FIG. 16.

FIG. 16 is a diagram designed to assist in explaining the detection of a position. In FIG. 16, the first sensor controller 160 receives information regarding a position indication from the transmitting electrodes 111 and 112 and the receiving electrodes 113. In addition, the second sensor controller 170 receives information regarding a position indication from the transmitting electrodes 111 and 112 and the receiving electrodes 114.

When the first sensor controller 160 detects a position indication at a point P90 that moves in the rightward direction in the region A1, the first sensor controller 160 generates electrode information according to the detection, and transmits the generated electrode information to the second sensor controller 170. The second sensor controller 170 converts information regarding the position indication, which is included in the electrode information, from the first sensor controller 160 into information related to the region including the regions A1 and A2, and transmits the converted information to another device in the apparatus 20 mounted with the position detecting device 1C.

In addition, when a point P91 approaches the boundary between the region A1 and the region A2 in the region A103 and the position indication ceases to be detected, the first sensor controller 160 sets, as the electrode information, information regarding the position indication detected last at the point 91 in the region A103, and transmits the electrode information to the second sensor controller 170. The second sensor controller 170 receives the information regarding the position indication, which is included in the electrode information, from the first sensor controller 160, and makes a setting for processing of detecting a position in the region A2 of the sensor panel 10C.

In addition, when the second sensor controller 170 detects the position indication at a point P92 that moves in the rightward direction in the region A2, the second sensor controller 170 converts information regarding the position indication into information related to the region including the regions A1 and A2 according to the detection, and transmits the converted information to another device in the apparatus 20 mounted with the position detecting device 1C.

According to this configuration, the first sensor controller 160 detects a position indication in the region A103, and when the detected position indication ceases to be detected with the passage of time, the first sensor controller 160 transmits information regarding the position indication detected last prior to the non-detection in the region A103 as the electrode information to the second sensor controller 170. In addition, the second sensor controller 170 makes a setting for detection according to the received electrode information. Hence, the position detecting device 1E can reduce disappearance and overlap of the position indication in the vicinity of the regions A1 and A2.

1. A position detecting device comprising:
a sensor panel having a first receiving electrode, a first transmitting electrode disposed so as to perpendicularly intersect the first receiving electrode, a second transmitting electrode having a first end adjacent to a first end of the first transmitting electrode and disposed so as to extend in a direction parallel with the first transmitting electrode, and a second receiving electrode disposed so as to perpendicularly intersect the second transmitting electrode;
a first sensor controller configured to detect a position on the sensor panel on a basis of signals detected by the first transmitting electrode and the first receiving electrode, generate electrode information related to the detection, and transmit the electrode information; and
a second sensor controller configured to, on a basis of the electrode information transmitted from the first sensor controller, make a setting for processing of detecting a position on the sensor panel on a basis of signals detected from the second transmitting electrode and the second receiving electrode.

2. A position detecting device comprising:
a sensor panel having a first transmitting electrode, a first receiving electrode disposed so as to perpendicularly intersect the first transmitting electrode, a second receiving electrode disposed in parallel with the first receiving electrode, and a third transmitting electrode perpendicularly intersecting the first receiving electrode and the second receiving electrode and arranged in parallel with the first transmitting electrode;
a first sensor controller configured to detect a position on the sensor panel on a basis of signals detected by the first transmitting electrode and the first receiving electrode, generate electrode information related to the detection, and transmit the electrode information; and
a second sensor controller configured to, on a basis of the electrode information transmitted from the first sensor controller, make a setting for processing of detecting a position on the sensor panel on a basis of signals detected from the second receiving electrode and the third transmitting electrode.

3. The position detecting device according to claim 1, wherein,
on a basis of the signals detected by the first transmitting electrode and the first receiving electrode, the first sensor controller generates detection information indicating whether the signals are detected, and generates the electrode information including the generated detection information.

4. The position detecting device according to claim 1, wherein
a plurality of the first transmitting electrodes and a plurality of the first receiving electrodes are arranged on the sensor panel, and
the first sensor controller generates position information indicating a position in a region in which the plurality of first transmitting electrodes and the plurality of first receiving electrodes intersect each other on a basis of signals detected by the first transmitting electrodes and the first receiving electrodes, and generates the electrode information including the generated position information.

5. The position detecting device according to claim 4, wherein
the position information includes electrode identifying information indicating which of the plurality of first transmitting electrodes and the plurality of first receiving electrodes has detected a signal.

6. The position detecting device according to claim 4, wherein
the position information includes coordinate information indicating the position in the region in which the plurality of first transmitting electrodes and the plurality of first receiving electrodes intersect each other.

7. The position detecting device according to claim 6, wherein
the first sensor controller generates movement information including a movement direction and a movement speed of the position indicated by the coordinate information on a basis of a change between past coordinate information and present coordinate information, and includes the generated movement information in the position information.

8. The position detecting device according to claim 7, wherein
the first sensor controller generates prediction information indicating a position to be reached by the position indicated by the coordinate information after passage of a predetermined time on a basis of the movement information, and includes the generated prediction information in the position information.

9. The position detecting device according to claim 1, wherein
a plurality of the first transmitting electrodes, a plurality of the first receiving electrodes, a plurality of the second transmitting electrodes, and a plurality of the second receiving electrodes are arranged on the sensor panel, and
the second sensor controller makes the setting so as to transmit a signal for position detection from the second transmitting electrodes in a vicinity of the position indicated by the electrode information according to the electrode information transmitted from the first sensor controller.

10. The position detecting device according to claim 1, wherein
the second sensor controller makes the setting so as to increase a frequency of transmitting a signal for position detection from the transmitting electrode connected to the second sensor controller via a signal line according to the electrode information transmitted from the first sensor controller.

11. The position detecting device according to claim 1, wherein
a plurality of the first transmitting electrodes and a plurality of the first receiving electrodes are arranged on the sensor panel, and
the first sensor controller performs an integral operation on each of signals detected by the first transmitting electrodes and the first receiving electrodes with a corresponding array of the electrodes as a reference, and generates the electrode information so as to include a result of the integral operation.

12. The position detecting device according to claim 1, wherein
a plurality of the first transmitting electrodes and a plurality of the first receiving electrodes are arranged on the sensor panel, and
the first sensor controller determines, for each of signals detected by the first transmitting electrodes and the first receiving electrodes, whether or not a voltage value of the signal is equal to or higher than a second reference value, and generates the electrode information so as to associate electrode identifying information of an electrode, for which the determination is a positive determination, and the voltage value of the signal detected by the electrode with each other.

13. The position detecting device according to claim 1, wherein
a plurality of the first transmitting electrodes, a plurality of the first receiving electrodes, a plurality of the second transmitting electrodes, and a plurality of the second receiving electrodes are arranged on the sensor panel, and,
on a basis of signals detected by electrodes connected to the second sensor controller via signal lines and the electrode information, the second sensor controller detects a maximal value of voltage values of the respective signals as the position on the sensor panel.

14. The position detecting device according to claim 1, wherein
a plurality of the first transmitting electrodes and a plurality of the first receiving electrodes are arranged on the sensor panel, and
the first sensor controller calculates each of a zeroth-order moment value and a first-order moment value for the first transmitting electrodes and the first receiving electrodes on a basis of voltage values of respective signals detected by the first transmitting electrodes and the first receiving electrodes and distances of the electrodes detecting the signals from a reference position, and generates the electrode information so as to include the calculated zeroth-order moment value and the calculated first-order moment value.

15. The position detecting device according to claim 14, wherein
a plurality of the second transmitting electrodes and a plurality of the second receiving electrodes are arranged on the sensor panel, and
the second sensor controller calculates each of a zeroth-order moment value and a first-order moment value for the second transmitting electrodes and the second receiving electrodes on a basis of voltage values of respective signals detected by the second transmitting electrodes and the second receiving electrodes and distances of the electrodes detecting the signals from a reference position, calculates a gravity center of a detected region on the sensor panel detected by the first transmitting electrodes, the second transmitting electrodes, and the first receiving electrodes on a basis of the calculated zeroth-order moment value and the calculated first-order moment value and the zeroth-order moment value and the first-order moment value included in the electrode information, and detects the calculated gravity center as the position on the sensor panel.

16. The position detecting device according to claim 2, wherein
a plurality of the first transmitting electrodes, a plurality of the first receiving electrodes, a plurality of the third transmitting electrodes, and a plurality of the second receiving electrodes are arranged on the sensor panel,
the sensor panel has a first region including the plurality of first receiving electrodes and the second receiving electrode arranged in a vicinity of the first receiving electrodes among the plurality of second receiving electrodes and a second region including the plurality of second receiving electrodes and the first receiving electrode arranged in a vicinity of the second receiving electrodes among the plurality of first receiving electrodes and overlapping the first region as viewed in plan,
the first sensor controller detects a position in the first region, and detects a position in an overlap region as a region in which the first region and the second region overlap each other as viewed in plan in a first period in detecting the position in the first region, and
the second sensor controller detects a position in the second region, and detects a position in the overlap region in a second period continuous with the first period in detecting the position in the second region.

17. A position detecting device comprising:
a sensor panel having a first receiving electrode, a first transmitting electrode disposed so as to perpendicularly intersect the first receiving electrode, a second transmitting electrode disposed so as to extend in a direction parallel with the first transmitting electrode such that a first end of the second transmitting electrode is adjacent to a first end of the first transmitting electrode, and a second receiving electrode disposed so as to perpendicularly intersect the second transmitting electrode; and
a sensor controller configured to detect a position on the sensor panel on a basis of signals detected by the first transmitting electrode and the first receiving electrode, generate electrode information related to the detection, and make a setting for detection processing for position detection on the sensor panel by the second transmitting electrode and the second receiving electrode according to the electrode information.

18. The position detecting device according to claim 17, wherein
a plurality of the first transmitting electrodes, a plurality of the first receiving electrodes, a plurality of the second transmitting electrodes, and a plurality of the second receiving electrodes are arranged on the sensor panel, and
the sensor controller makes the setting according to the electrode information so as to transmit a signal for position detection from the second transmitting electrodes in a vicinity of the position indicated by the electrode information.

19. The position detecting device according to claim 17, wherein
the sensor controller makes the setting according to the electrode information so as to increase a frequency of transmitting a signal for position detection from the second transmitting electrode.

20. A sensor panel comprising:
a first receiving electrode arranged in parallel;
a first transmitting electrode arranged so as to perpendicularly intersect the first receiving electrode;
a second transmitting electrode disposed so as to extend in a direction parallel with the first transmitting electrode such that a first end of the second transmitting electrode is adjacent to a first end of the first transmitting electrode;
a second receiving electrode disposed so as to perpendicularly intersect the second transmitting electrode;
a first signal line having a first end connected to a second end of the first transmitting electrode;
a second signal line having a first end connected to a second end of the second transmitting electrode;
a third signal line having a first end connected to a first end of the first receiving electrode and disposed between the first signal line and the second signal line; and
a fourth signal line having a first end connected to a first end of the second receiving electrode and disposed between the second signal line and the third signal line.

21. The sensor panel according to claim 20, wherein
the first ends of the first transmitting electrode and the second transmitting electrode are formed in a comb tooth shape, and
the first end of the first transmitting electrode is formed so as to have a comb tooth-shaped recessed portion meshing with a comb tooth-shaped projecting portion of the first end of the second transmitting electrode and have a comb tooth-shaped projecting portion meshing with a comb tooth-shaped recessed portion of the first end of the second transmitting electrode.

22. A position detecting device comprising:
a sensor panel formed by arranging a plurality of electrodes for position detection in a planar shape such that the plurality of electrodes intersect each other, the sensor panel having a first region that is one of regions in which the plurality of electrodes intersect each other, a second region that is one of the regions in which the plurality of electrodes intersect each other, the second region partly overlapping the first region as viewed in plan and being different from the first region, and an overlap region that is a region in which the first region and the second region overlap each other as viewed in plan;
a first sensor controller configured to detect a position in the first region, and detect a position in the overlap region in a first period in detecting the position in the first region; and
a second sensor controller configured to detect a position in the second region, and detect a position in the overlap region in a second period continuous with the first period in detecting the position in the second region.

23. The position detecting device according to claim 22, wherein
the first sensor controller generates electrode information related to the detection of the position in the overlap region, and transmits the electrode information to the second sensor controller, and
the second sensor controller makes a setting for processing of detecting the position in the overlap region on a basis of the electrode information transmitted from the first sensor controller.

24. The position detecting device according to claim 23, wherein
the electrode information includes coordinate information indicating the position in the overlap region, and
the second sensor controller detects a position in a region in a vicinity of the position indicated by the coordinate information in the second period.
